(19) United States
(12) Patent Application Publication
(10) Pub. No.: US 2014/0026139 A1
(43) Pub. Date: Jan. 23, 2014

(54) INFORMATION PROCESSING APPARATUS AND ANALYSIS METHOD

(71) Applicant: FUJITSU LIMITED, Kawasaki-shi (JP)

(72) Inventor: Koji TAKAHARA, Yokohama (JP)

(73) Assignee: FUJITSU LIMITED, Kawasaki-shi (JP)

(21) Appl. No.: 14/035,145

(22) Filed: Sep. 24, 2013

Related U.S. Application Data
(63) Continuation of application No. PCT/JP2011/057989, filed on Mar. 30, 2011.

(51) Int. Cl. G06F 9/54

(52) U.S. Cl. CPC G06F 9/54
USPC 718/102

(57) ABSTRACT

A determination unit determines which one of a first and a second method has shorter response time when the first method is to analyze, in real time, all of information items designated as analysis targets in an analysis request and the second method is to analyze, in non-real time, some of the information items and analyze the remaining information items in real time. If the first method has shorter response time, an analysis management unit causes a first process unit to analyze all the information items in real time. If the second method has shorter response time, the analysis management unit causes the first process unit to analyze, in real time, information items other than the information items to be analyzed in non-real time, and causes a second process unit to analyze, in non-real time, the information items to be analyzed in non-real time.

### CROSS-REFERENCE TO RELATED APPLICATION

This application is a continuation application of International Application PCT/JP2011/057989 filed on Mar. 30, 2011 which designated the U.S., the entire contents of which are incorporated herein by reference.

### FIELD

The embodiments discussed herein are related to an information processing apparatus and an analysis method.

### BACKGROUND

Outputting data such as time stamps for the time of function calls is known as one technique useful for program debugging. A function is a program executed when called by another program using a predetermined function name. For example, by acquiring time stamps for the time of function calls, it is possible to obtain information on characteristics in the execution of a program, for example, access frequencies for functions and variables during the execution of the program. Such information on characteristics in the execution of a program is usable for, for example, memory layout optimization and download optimization. To analyze predetermined information and output the analysis result each time a function is called is referred to as ‘tracing the function’, and this functional capability is called the ‘capability of tracing function calls’.

For example, a technology has been proposed which allows data reference during execution of a program to be implemented by a trace function call. According to this technology, a data reference instruction in the program is replaced with a trace function call instruction. Then, when the execution of the program reaches the data reference instruction for the first time, the trace function call instruction is executed instead of the data reference instruction.

Japanese Laid-open Patent Publication No. 2003-140921

However, according to the conventional technology, when information analysis to trace a function call is taking place, a caller of the function (hereinafter, referred to as the ‘function caller’) is waiting for a response and, therefore, its processing is being suspended. Thus, the information analysis for tracing is a cause of delay in the processing of the function caller. For example, the information analysis takes a long time in the case where the tracing associated with a function call involves extensive analysis or a large amount of copying, thus causing significant delay in the processing of the function caller.

Note that the information analysis is carried out to trace not only calls to programs called functions, but also calls to various other types of programs. With regard to the case of calling a program other than a function, the information analysis to trace the program also causes delay in processing of a program caller, as in the case of calling a function.

### SUMMARY

According to one aspect, there is provided an information processing apparatus including a processor configured to perform a procedure which includes determining, based on an analysis request to analyze information related to a call to a first program, which one of a first and a second method has shorter time to respond to a caller when the call to the first program is made, the first method being to analyze, in real time, all of information items designated as analysis targets in the analysis request, and the second method being to analyze, in non-real time, some of the information items designated in the analysis request and analyze, in real time, information items other than the information items to be analyzed in non-real time; and carrying out, when the first method has shorter response time, a first task in real time at a time of execution of a call instruction to the first program during a course of execution of a second program including therein the call instruction to the first program, the first task including analysis of all of the information items designated in the analysis request, execution of processing of the first program, and a response to the call to the first program, and carrying out, when the second method has shorter response time, a second task in real time at the time of execution of the call instruction to the first program during the course of execution of the second program and a third task in non-real time, the second task including analysis of the information items other than the information items to be analyzed in non-real time, a request for analysis of the information items to be analyzed in non-real time, execution of processing of the first program, and a response to the call to the first program, and the third task including the analysis of the information items to be analyzed in non-real time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a functional configuration of an apparatus according to a first embodiment;

FIG. 2 is a flowchart illustrating a procedure example according to the first embodiment;

FIG. 3 illustrates an example of an analysis process according to the first embodiment;

FIG. 4 illustrates a hardware configuration example of a computer used in a second embodiment;

FIG. 5 is a block diagram illustrating functional capabilities of the computer according to the second embodiment;

FIG. 6 illustrates an example of a data configuration of packet information;

FIG. 7 is a first diagram illustrating processing status for the case of not acquiring trace information;

FIG. 8 is a second diagram illustrating processing status for the case of not acquiring trace information;

FIG. 9 is a first diagram illustrating processing status for the case of acquiring the trace information by a first method;

FIG. 10 is a second diagram illustrating processing status for the case of acquiring the trace information by the first method;

FIG. 11 is a first diagram illustrating processing status for the case of acquiring the trace information by a second method;

FIG. 12 is a second diagram illustrating processing status for the case of acquiring the trace information by the second method;

FIG. 13 is a flowchart illustrating a procedure of a trace management process;

FIG. 14 illustrates an example of data formats of a trace command and an output information designation file;

FIG. 15 illustrates a first example of an output result according to the trace command and the output information designation file;

FIG. 16 illustrates a second example of the output result according to the trace command and the output information designation file;

FIG. 17 illustrates an example of a data configuration of a common area;

FIG. 18 illustrates an example of a data configuration of a debug request structure;

FIG. 19 illustrates an example of a data configuration of a debug result structure;

FIG. 20 illustrates an example of a data configuration of an information linkage structure;

FIG. 21 illustrates an example of a linked relationship of information linkage structures;

FIG. 22 illustrates an example of a data configuration of a processing time information storing unit;

FIG. 23 is a flowchart illustrating a procedure of a trace setup process;

FIG. 24 is a flowchart illustrating a procedure example for calculating analysis time for non-real-time analysis information;

FIG. 25 is a flowchart illustrating a procedure example for calculating time for information handover to a trace managing unit;

FIG. 26 is a flowchart illustrating a procedure example for calculating time for information handover to a debug thread;

FIG. 27 illustrates an example of information provided in a time estimation table;

FIG. 28 is a flowchart illustrating a procedure example of a first debug process;

FIG. 29 is a flowchart illustrating a procedure example of a second debug process;

FIG. 30 is a flowchart illustrating a procedure example for setting up information handover to the debug thread; and

FIG. 31 illustrates a procedure example of processing of the debug thread.

### DESCRIPTION OF EMBODIMENTS

Several embodiments will be described below with reference to the accompanying drawings, wherein like reference numerals refer to like elements throughout. Note that two or more of the embodiments below may be combined for implementation in such a way that no contradiction arises.

### (a) First Embodiment

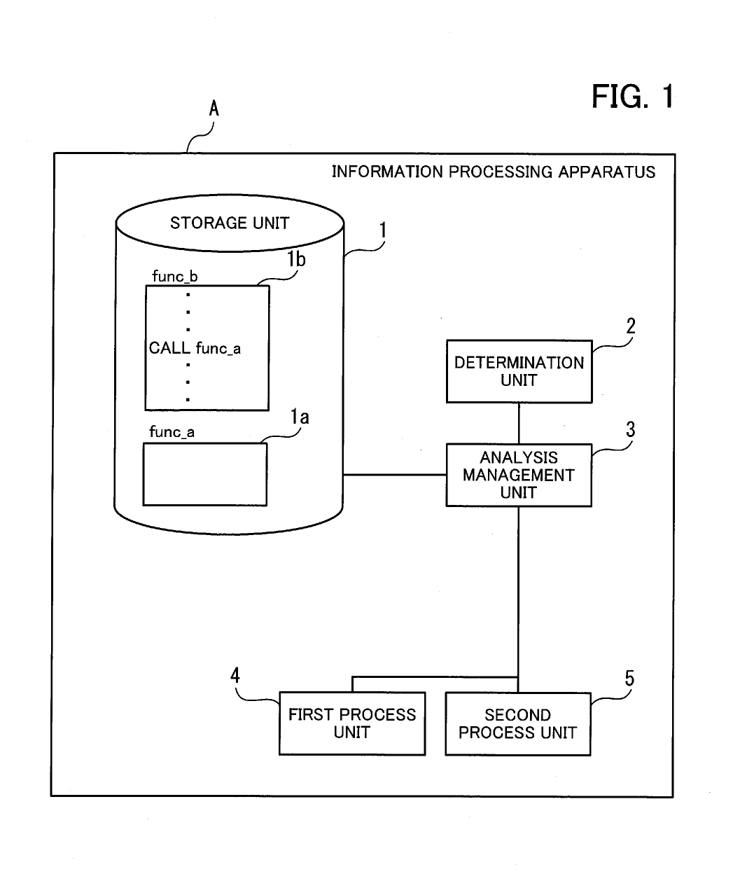

FIG. 1 illustrates an example of a functional configuration of an apparatus according to a first embodiment. An information processing apparatus A includes a storage unit 1, determination unit 2, analysis management unit 3, first process unit 4, and second process unit 5.

The storage unit 1 stores therein a first program 1a subject to analysis and a second program 1b including a call instruction to the first program 1a.

In the determination unit 2, a first method and a second method are defined as methods for analyzing information related to a call to the first program 1a. The first method is to analyze, in real time, all of information items designated as analysis targets in an analysis request. The second method is to analyze, in non-real time, some of the information items designated in the analysis request and analyze, in real time, information items other than those to be analyzed in non-real time. Based on the analysis request to analyze the information related to a call to the first program 1a, the determination unit 2 determines which one of the first and the second method has shorter time to respond to a program caller when a call to the first program 1a is made.

The information related to a call to the first program 1a includes, for example, information on a parameter added to the call instruction and information stored in a memory area identified by an address assigned to the parameter.

The analysis management unit 3 controls the first process unit 4 and the second process unit 5 to manage analysis according to a method having shorter response time. The first process unit 4 carries out processing in real time, and the second process unit 5 carries out processing in non-real time.

In the case where the first method has shorter response time, the analysis management unit 3 causes the first process unit 4 to carry out its processing when, during the course of execution of the second program 1b including a call instruction to the first program 1a, the call instruction to the first program 1a is executed. For example, the analysis management unit 3 causes the first process unit 4 to carry out the following tasks in real time: analysis of all of the information items designated in the analysis request; execution of processing of the first program 1a; and a response to the program call.

In the case where the second method has shorter response time, the analysis management unit 3 causes the first process unit 4 and the second process unit 5 to carry out individual processing when the call instruction to the first program 1a is executed during the course of execution of the second program 1b. For example, the analysis management unit 3 causes the first process unit 4 to carry out the following tasks in real time: analysis of information items other than those to be analyzed in non-real time among the information items designated in the analysis request; a request to the second process unit 5 to analyze the information items to be analyzed in non-real time; execution of processing of the first program 1a; and a response to the program call. In addition, the analysis management unit 3 causes the second process unit 5 to analyze, in non-real time, the information items to be analyzed in non-real time. Note that, in FIG. 1, each line connecting the individual components represents a part of communication paths, and communication paths other than those illustrated in FIG. 1 are also configurable.

The first process unit 4 and the second process unit 5 are achieved, for example, by implementing programs generated by the analysis management unit 3 according to the analysis request. In this case, the analysis management unit 3 rewrites, for example, the call instruction to the first program 1a in the second program 1b with a call instruction to a program corresponding to the first process unit 4. Further, the analysis management unit 3 writes the call instruction to the first program 1a in the program corresponding to the first process unit 4 to thereby cause the first program 1a to be called indirectly.

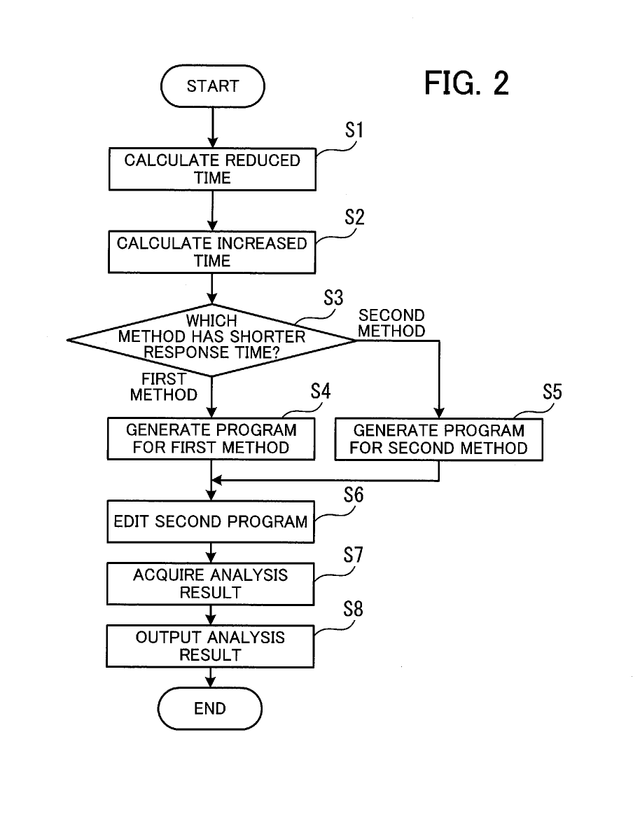

Next described is a processing procedure of the information processing apparatus A having the configuration of FIG. 1. FIG. 2 is a flowchart illustrating a procedure example according to the first embodiment. The process of FIG. 2 is described next according to the step numbers in the flowchart.

[Step S1] Upon acquisition of an analysis request to analyze information related to a call of the first program 1a, the determination unit 2 calculates processing time for tasks that the first process unit 4 does not have to carry out due to some of the information items designated in the analysis request being analyzed in non-real time. In other words, the determination unit 2 calculates the reduced time. The reduced time is obtained by, for example, adding the time for analyzing the information items to be analyzed in non-real time to the time for outputting the analysis result.

[Step S2] According to the analysis request, the determination unit 2 also calculates processing time for a newly emerging task which needs to be assumed by the first process unit 4 due to some of the information items designated in the analysis request being analyzed in non-real time. In other words, the determination unit 2 calculates the increased time. The increased time is, for example, a time taken for the first process unit 4 to request the second process unit 5 to analyze the information items to be analyzed in non-real time.

[Step S3] By comparing the reduced time and the increased time related to the processing of the first process unit 4, the determination unit 2 determines which one of the first and the second method has shorter time to respond to a program caller. For example, if the reduced time is shorter, the determination unit 2 determines that the first method results in shorter response time. On the other hand, if the reduced time is longer, the determination unit 2 determines that the second method results in shorter response time. If the method having shorter response time is the first method, the determination unit 2 proceeds to step S4. On the other hand, if the method having shorter response time is the second method, the determination unit 2 proceeds to step S5.

[Step S4] The analysis management unit 3 generates a program including processing contents of the first process unit 4 which carries out its processing according to the first method. For example, the analysis management unit 3 generates the program by adding a call instruction to the first program 1a to a prepared template program for the first method. Subsequently, the analysis management unit 3 proceeds to step S6.

[Step S5] The analysis management unit 3 generates a program including processing contents of the first process unit 4 which carries out its processing according to the second method. For example, the analysis management unit 3 generates the program by adding a call instruction to the first program 1a to a prepared template program for the second method. Subsequently, the analysis management unit 3 proceeds to step S6.

[Step S6] The analysis management unit 3 edits the second program 1b in such a manner that the program corresponding to the first process unit 4 is called when the call instruction to the first program 1a is executed during the course of execution of the second program 1b. For example, the analysis management unit 3 rewrites the call instruction to the first program 1a in the second program 1b with a call instruction to the program corresponding to the first process unit 4. In the case where the second program 1b has already been loaded in a main storage unit, the rewriting of the call instruction is made to the second program 1b stored in the main storage unit. If the second program 1b is not loaded in the main storage unit, the rewriting of the call statement is made to the second program 1b stored, for example, in a secondary storage unit.

When it is time to execute the first program 1a after the second program 1b is started by an operating system (OS), the call instruction to the program corresponding to the first process unit 4 is executed. In response, the first process unit 4 is executed by the OS. In the case of applying the first method, the first process unit 4 analyzes, in real time, all the information items designated as analysis targets in the analysis request. In the case of applying the second method, the first process unit 4 analyzes, in real time, information items other than those to be analyzed in non-real time, and the second process unit 5 analyzes, in non-real time, the information items to be analyzed in non-real time.

[Step S7] The analysis management unit 3 acquires an analysis result from the first process unit 4 or the second process unit 5.

[Step S8] The analysis management unit 3 outputs the analysis result.

In the above-described manner, information related to a call to the first program 1a is analyzed according to a method having shorter response time.

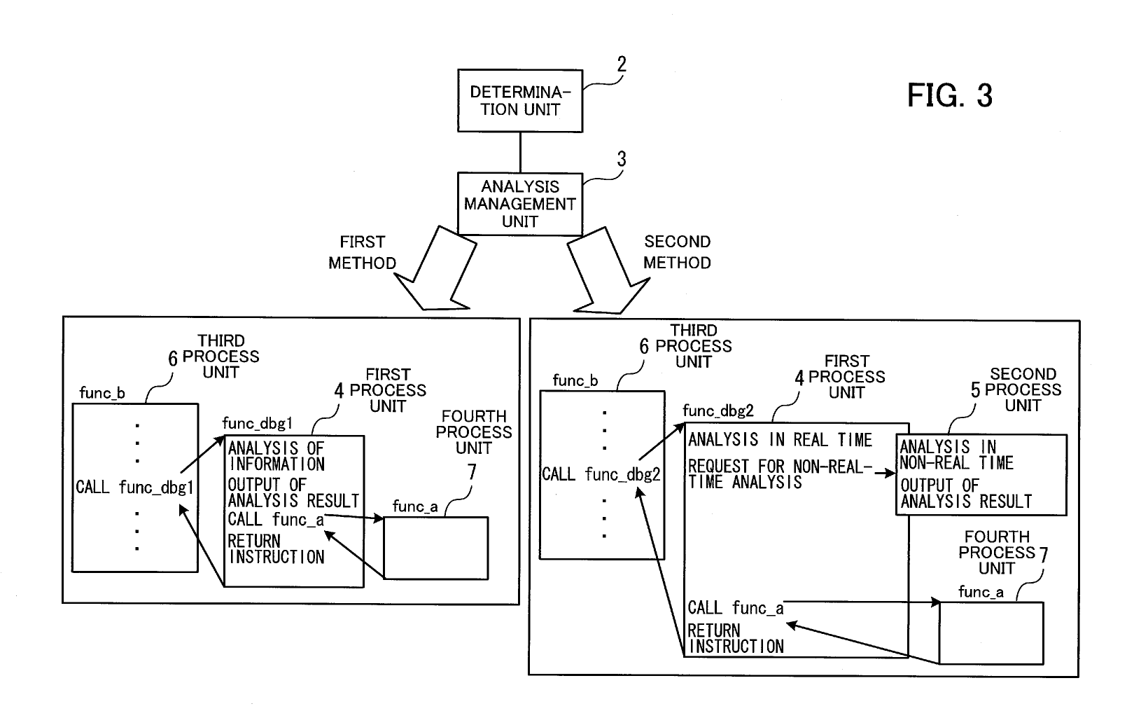

FIG. 3 illustrates an example of an analysis process according to the first embodiment. FIG. 3 schematically represents an analysis process carried out under the management of the analysis management unit 3 according to the determination result of the determination unit 2.

In the case where the first method is determined to have shorter response time, third process unit 6 for executing the second program 1b is generated, which is followed by the execution of the second program 1b. When it is time to execute a call instruction ‘call func_dbg1’ to the program corresponding to the first process unit 4, the third process unit 6 calls the program and, then, waits for a response. Subsequently, the first process unit is started by the OS to analyze all the information items designated in the analysis request and output the analysis result. Then, the first process unit 4 executes a call instruction ‘call func_a’ to the first program 1a. In response, fourth process unit 7 for executing the first program 1a is started by the OS, which is followed by the execution of the first program 1a. When processing of the first program 1a is completed, the fourth process unit 7 responds to the first process unit 4 with the processing result. The first process unit 4 responds to the third process unit 6 with the processing result of the fourth process unit 7. In response, the third process unit 6 starts its processing from a process following the call instruction ‘call func_dbg1’ to the program corresponding to the first process unit 4.

In the case where the second method is determined to have shorter response time, the third process unit 6 for executing the second program 1b is generated, which is followed by the execution of the second program 1b. When it is time to execute a call instruction ‘call func_dbg2’ to the program corresponding to the first process unit 4, the third process unit 6 calls the program and, then, waits for a response. Subsequently, the first process unit 4 is started by the OS to analyze, among all the information items designated in the analysis request, information items to be analyzed in real time and request the second process unit 5 to analyze information items to be analyzed in non-real time. Then, the first process unit 4 executes the call instruction ‘call func_a’ to the first program 1a. In response, the fourth process unit 7 for executing the first program 1a is started by the OS, which is followed by the execution of the first program 1a. When processing of the first program 1a is completed, the fourth process unit 7 responds to the first process unit 4 with the processing result. The first process unit 4 responds to the third process unit 6 with the processing result of the fourth process unit 7. In response, the third process unit 6 starts its processing from a process following the call instruction ‘call func_dbg2’ to the program corresponding to the first process unit 4. On the other hand, the second process unit 5 analyzes the information items to be analyzed in non-real time. Subsequently, the second process unit 5 outputs an analysis result by combining analysis results for all the information items designated in the analysis request.

In the above-described manner, information related to a program call is analyzed according to a method having shorter response time, which reduces the time for the third process unit 6 to wait for a response. In this manner, it is possible to prevent the analysis from having a significant influence on processing of the third process unit 6. For example, it is sometimes the case that information related to a program call is analyzed while a system is in operation. In such a case, making the analysis according to the first embodiment minimizes a reduction in the processing performance of the system in operation.

In addition, if the time for the third process unit 6 to wait for a response is prolonged, correct analysis may not be possible. For example, a particular description may be provided in the second program 1b, which is the caller of the first program 1a, so that error processing is carried out when the response time exceeds a predetermined time after the execution of the call instruction to the first program 1a. In such a case, if the error processing is started due to the analysis of information related to a program call, operations during normal times may fail to be properly analyzed. Therefore, the first embodiment leads to a better chance of properly analyzing operations during normal times.

Note that the determination unit 2, the analysis management unit 3, the first process unit 4, the second process unit 5, the third process unit 6, and the fourth process unit 7 of FIGS. 1 and 3 may be implemented by a central processing unit (CPU) of the information processing apparatus A. In addition, the storage unit 1 may be implemented, for example, by a random access memory (RAM) or a hard disk drive (HDD) of the information processing apparatus A.

### (b) Second Embodiment

A second embodiment is described next. The second embodiment is provided with an additional capability along with the functional capabilities described in the first embodiment, which additional capability is to set conditions of information to be output so as to output only needed information.

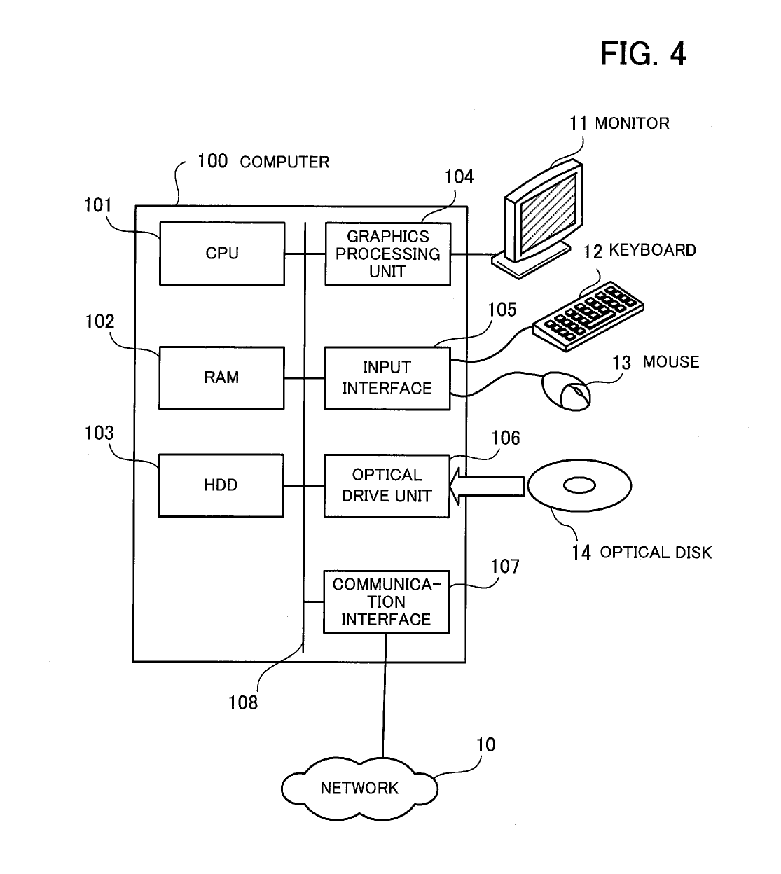

FIG. 4 illustrates a hardware configuration example of a computer used in the second embodiment. Overall control of a computer 100 is exercised by a CPU 101. To the CPU 101, a RAM 102 and multiple peripherals are connected via a bus 108.

The RAM 102 is used as a main storage device of the computer 100. The RAM 102 temporarily stores at least part of an OS program and application programs to be executed by the CPU 101. The RAM 102 also stores therein various types of data to be used by the CPU 101 for its processing.

The peripherals connected to the bus 108 include a HDD 103, a graphics processing unit 104, an input interface 105, an optical drive unit 106, and a communication interface 107.

The HDD 103 magnetically writes and reads data to and from a built-in disk, and is used as a secondary storage device of the computer 100. The HDD 103 stores therein the OS program, application programs, and various types of data. Note that a semiconductor storage device such as a flash memory may be used as a secondary storage device in place of the HDD 103.

To the graphics processing unit 104, a monitor 11 is connected. According to an instruction from the CPU 101, the graphics processing unit 104 displays an image on a screen of the monitor 11. A cathode ray tube (CRT) display or a liquid crystal display, for example, may be used as the monitor 11.

To the input interface 105, a keyboard 12 and a mouse 13 are connected. The input interface 105 transmits signals sent from the keyboard 12 and the mouse 13 to the CPU 101. Note that the mouse 13 is just an example of pointing devices, and a different pointing device such as a touch panel, a tablet, a touch-pad, and a trackball, may be used instead.

The optical drive unit 106 reads data recorded on an optical disk 14 using, for example, laser light. The optical disk 14 is a portable recording medium on which data is recorded in such a manner as to be read by reflection of light. Examples of the optical disk 14 include a digital versatile disc (DVD), a DVD-RAM, a compact disk read only memory (CD-ROM), a CD recordable (CD-R), and a CD-rewritable (CD-RW).

The communication interface 107 is connected to a network 10. Via the network 10, the communication interface 107 transmits and receives data to and from different computers and communication devices.

The hardware configuration described above achieves the processing features of this embodiment. Note that the information processing apparatus A according to the first embodiment of FIG. 1 may be constructed with the same hardware configuration as the computer 100 of FIG. 4.

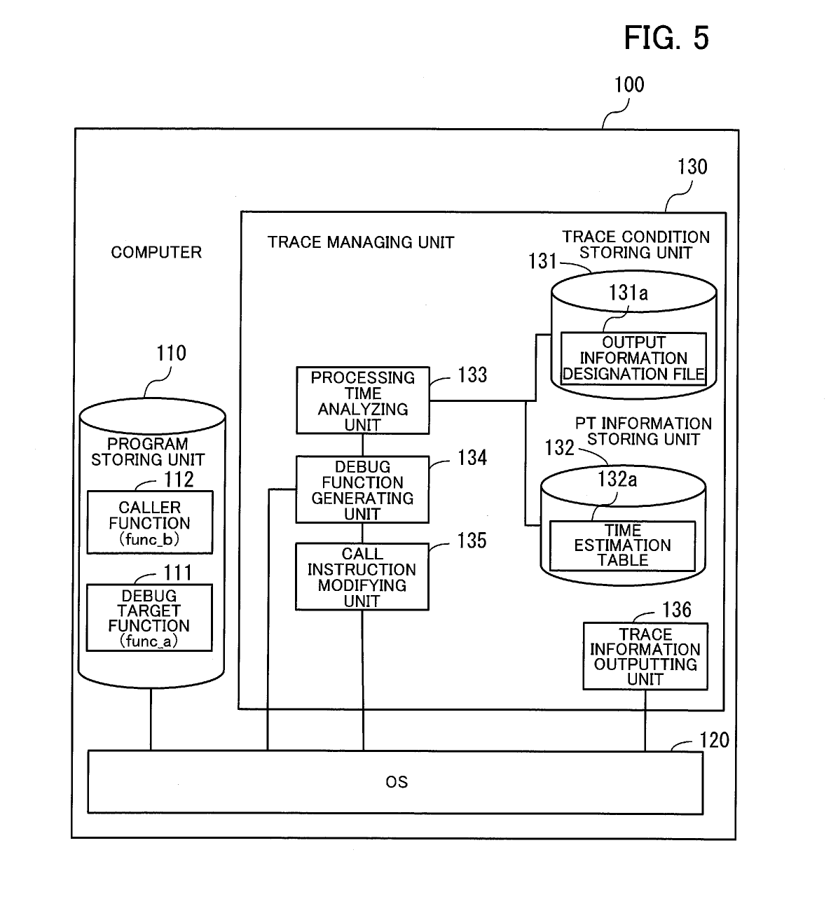

FIG. 5 is a block diagram illustrating functional capabilities of a computer according to the second embodiment. The computer 100 includes a program storing unit 110, an OS 120, and a trace managing unit 130.

The program storing unit 110 stores therein a debug target function 111 subject to debugging and a caller function 112 for calling a program of the debug target function 111. In the case where a debug function generating unit 134 of the trace managing unit 130 generates a debug program, the generated debug program is also stored in the program storing unit 110. A part of the memory area of the RAM 102 or the HDD 103, for example, may be used as the program storing unit 110.

In response to a request for execution of a program, the OS 120 generates a process to execute the program and then executes the program according to the generated process. For the process, the OS 120 allocates hardware resources such as the CPU 101, the RAM 102, and input/output (I/O) devices, and then the process executes the program using the allocated hardware resources.

The OS 120 adopting memory management of a virtual storage system segregates its virtual memory into kernel space and user space. The kernel space is a memory space for executing a kernel and device drivers in the OS 120, and is restricted from direct user operation. The user space is a memory space for executing application programs and the like. According to the example of FIG. 5, individual functional capabilities of the trace managing unit 130 are executed in the user space. On the other hand, assume here that the caller function 112 and the debug target function 111 are, for example, device driver programs, and are executed by the OS 120 in the kernel space.

In response to a request for execution of a trace command, the trace managing unit 130 traces information on execution of the debug target function 111. The trace managing unit 130 includes a trace condition storing unit 131, a processing time (PT) information storing unit 132, a processing time analyzing unit 133, the debug function generating unit 134, a call instruction modifying unit 135, and a trace information outputting unit 136.

The trace condition storing unit 131 stores therein conditions used to trace data during execution of a program. The trace condition storing unit 131 stores therein, for example, an output information designation file 131a including trace conditions. Note that a part of the memory area of the RAM 102 or the HDD 103, for example, may be used as the trace condition storing unit 131.

The processing time information storing unit 132 stores therein information to be the basis for calculating time for information tracing. For example, the processing time information storing unit 132 stores processing time for each processing content. Note that a part of the memory area of the RAM 102 or the HDD 103, for example, may be used as the processing time information storing unit 132.

With respect to each of the two methods, the processing time analyzing unit 133 calculates time for a trace process based on contents of the output information designation file 131a indicated by the trace command.

The first method is to analyze both information to be analyzed in real time (hereinafter referred to as the ‘real-time analysis information’) and information not to be analyzed in real time (‘non-real-time analysis information’) according to a process for executing debugging in real time.

The second method is to analyze the real-time analysis information and the non-real-time analysis information in parallel. Specifically, the real-time analysis information is analyzed according to the process for executing debugging in real time, and the non-real-time analysis information is analyzed in a debug thread different from the process for executing debugging.

The process time analyzing unit 133 compares processing time for a debug function according to the two individual methods, and determines a method having shorter processing time as an applicable method. The processing time analyzing unit 133 reports the determined applicable method to the debug function generating unit 134.

The debug function generating unit 134 generates a debug program for carrying out the applicable method. For example, the debug function generating unit 134 generates the debug program using a template program, which is prepared for each of the first and the second method. In the case of using such a template program, the debug function generating unit 134 inserts a call instruction to the debug target function 111 into the template program, at a position following a description related to the trace process for the real-time analysis. Subsequently, the debug function generating unit 134 stores the generated debug program in the program storing unit 110. In addition, in the case of applying the second method to data tracing in the debug process, the debug function generating unit 134 requests the OS 120 to generate a debug thread.

The call instruction modifying unit 135 replaces the call instruction to the debug target function 111 in the caller function 112 with a call instruction to the debug function generated by the debug function generating unit 134. For example, after loading the caller function 112 in the kernel space, the call instruction modifying unit 135 is able to replace function call instructions in the kernel space. The term “loading” here means to copy a program stored in a secondary storage unit (such as the HDD 103) into a main storage unit (such as the RAM 102).

The trace information outputting unit 136 acquires trace information, which is an analysis result, from the OS 120 executing the debug function or from the debug thread generated in the kernel space by the OS 120. Subsequently, the trace information outputting unit 136 outputs the acquired trace information. For example, the trace information outputting unit 136 outputs the trace information to a predetermined file.

According to the computer 100 described above, by inputting a trace command thereto, a user is able to acquire trace information related to a calling process of the debug target function 111 executed during the course of execution of the caller function 112. Note that, in FIG. 5, each line connecting the individual components represents a part of communication paths, and communication paths other than those illustrated in FIG. 1 are also configurable.

The program storing unit 110 of FIG. 5 is an example of the storage unit 1 of the first embodiment of FIG. 1. In addition, the processing time analyzing unit 133 of FIG. 5 is an example of the determination unit 2 of the first embodiment of FIG. 1. Further, an integrated assembly of the debug function generating unit 134, the call instruction modifying unit 135, and the trace information outputting unit 136 of FIG. 5 is an example of the analysis management unit 3 of the first embodiment of FIG. 1.

Next described are real-time analysis information and non-real-time analysis information. Examples of real-time analysis information are a time stamp and a stack. A time stamp is information on the time when a corresponding function call instruction is executed. Acquiring a time stamp in real time at the execution of the function call instruction allows acquisition of the exact time. A stack of a function indicates a caller function of a corresponding function. In the case where Function A was called by Function B, which was called by Function C, which was again called by Function D, a stack of Function A represents a path of: Function A←Function B←Function C←Function D. An example of non-real-time analysis information is packet information received through a network driver. Such packet information is stored, for example, in a memory area identified by an address assigned to a parameter of a function call instruction.

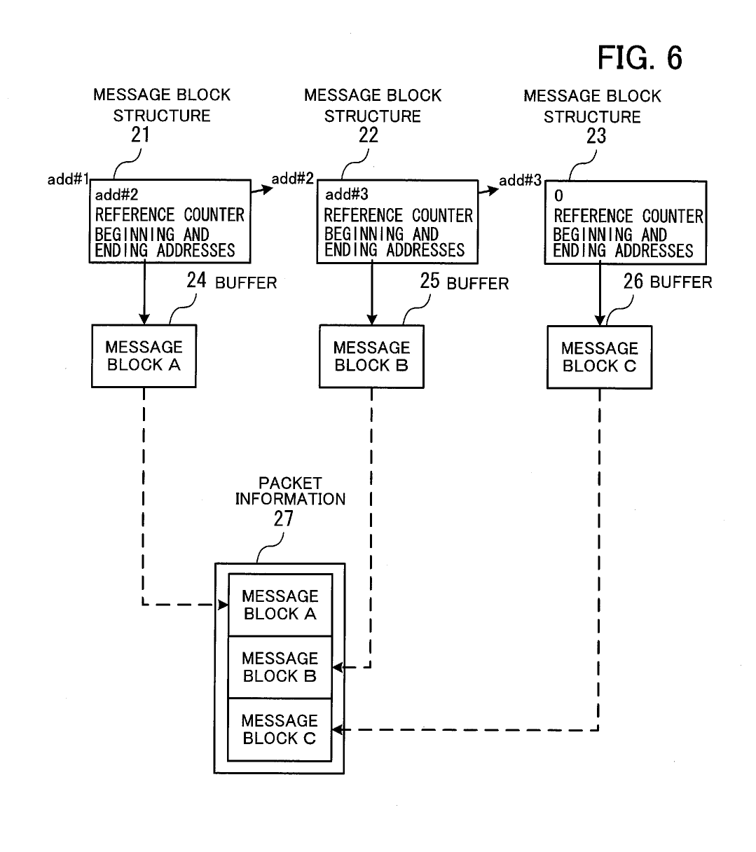

FIG. 6 illustrates an example of a data configuration of packet information. Packet information received through a network driver has a data configuration in which message block structures 21 to 23 are linked to one another, and individually have beginning and ending addresses of buffers 24 to 26, respectively. Each of the message block structures 21 to 23 is provided with a pointer indicating a position of a message block structure following the message block structure. Thus, the pointers of the message block structures 21 to 23 denote a linked relationship among the message block structures 21 to 23.

The beginning address of the first message block structure 21 is received by a transmission function or a reception function of the network driver. Note that there is not a limit on the number of message block structures. For example, there may be only one message block structure, or ten message block structures.

On the basis that packet information 27 is used by multiple modules, a reference counter provided for each of the message block structures 21 to 23 indicates the number of modules currently referring to the corresponding message block structure. Unless the reference counter of the first message block structure 21 becomes zero, memory for the message block structures 21 to 23 having a linked relationship and the buffers 24 to 26 is not released. Therefore, as for the packet information 27 received through the network driver, adding one to the reference counter of the message block structure 21 prevents the memory area storing the packet information 27 therein from being released.

There is no need to analyze, in real time, information for which release of its memory area is readily prevented, like the packet information 27. That is, it is possible to analyze the information in non-real time by preventing the area storing the information from being released, without having to analyze the information in real time.

Thus, information items to be traced at the time of debugging may include those analyzable in non-real time. If the non-real-time analysis information items take long to be analyzed, it is possible to reduce response delay due to the execution of debugging by causing a debug thread different from the process for executing debugging to analyze the non-real-time analysis information items. Note however that it also takes a certain amount of time to request the debug thread to analyze the non-real-time analysis information items. As a result, the processing time reduced by not analyzing, in real time, the non-real-time analysis information items may be shorter than the time taken to make the processing request to the debug thread. In such a case, it is efficient to carry out analysis in real time, including analysis of the non-real-time analysis information items, in the process for executing debugging. According to the second embodiment, trace information is acquired using one of the first and the second method which has shorter response time to the caller.

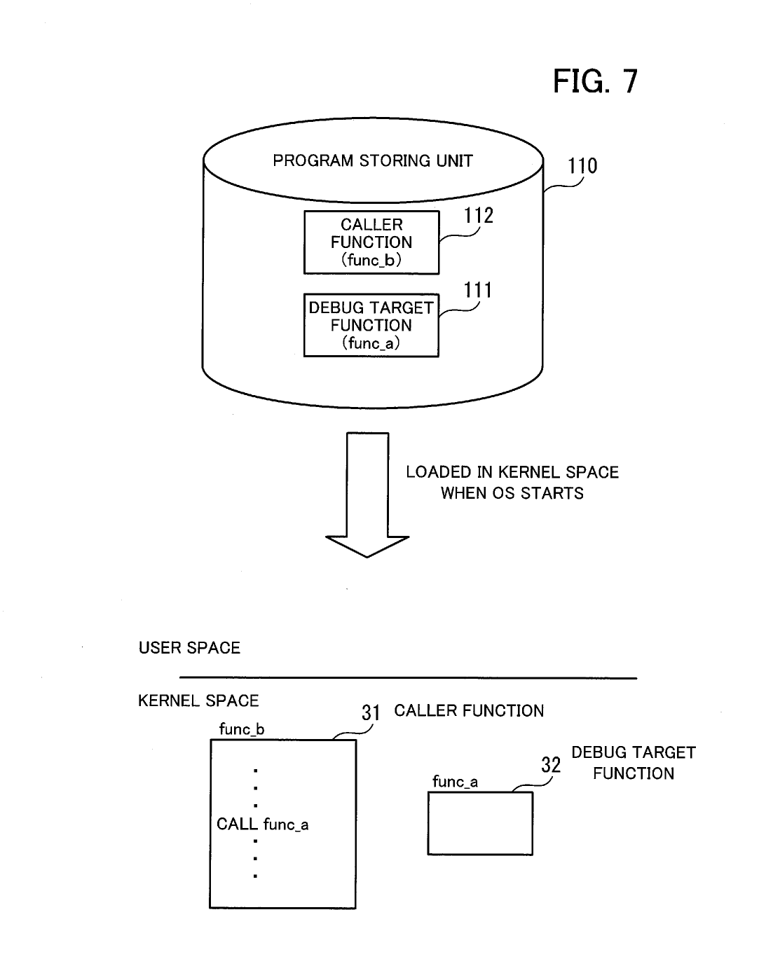

With reference to FIGS. 7 to 12, next described is an overview of execution status of the caller function 112 for each of the following cases: no trace information being acquired; trace information being acquired by the first method; and trace information being acquired by the second method.

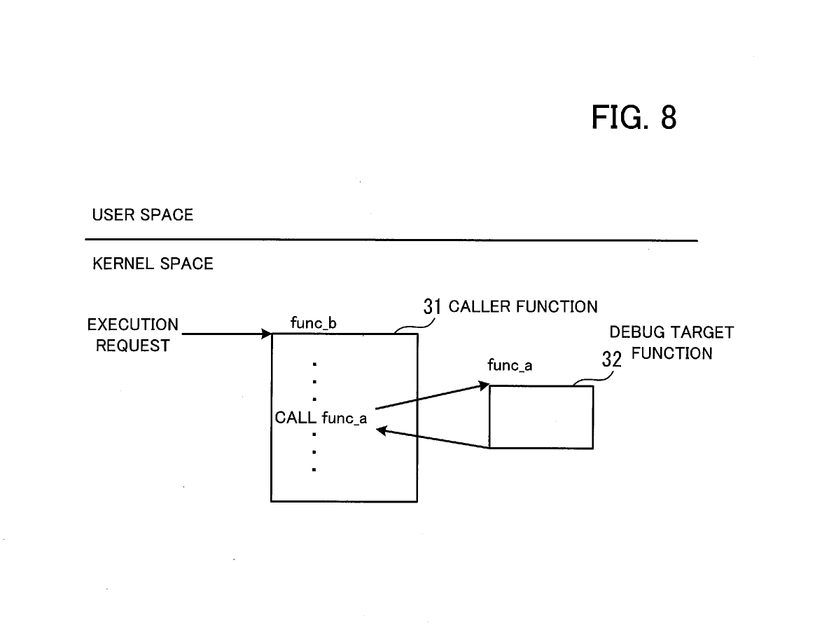

FIGS. 7 and 8 illustrate an example in which no trace information is acquired. According to the example of FIGS. 7 and 8, a request for execution of a trace command is not input to the computer 100 and, therefore, the trace managing unit 130 is not started.

FIG. 7 is a first diagram illustrating processing status for the case of not acquiring trace information. When the OS 120 starts, the caller function 112 and the debug target function 111 are loaded in the kernel space of the memory. With this, a caller function 31 and a debug target function 32 are stored in the kernel space. In addition, inside the OS 120, a code to call the caller function 31 is generated using a function name ‘func_b’ of the caller function 31. When it is time to execute the caller function 31 during the course of execution of each processing, the OS 120 issues a request for execution of the caller function 31 (i.e. a function call) based on the generated code. Note that the caller function 112 and the debug target function 111 may be loaded in the kernel space of the memory at some point in time after the OS 120 has started.

Programs, such as functions, loaded in the kernel space are implemented as functional capabilities of the OS 120. In this view, assume in the following that programs loaded in the kernel space are executed by the OS 120.

FIG. 8 is a second diagram illustrating processing status for the case of not acquiring trace information. In this status, when a request to execute the caller function 31 (a function call) occurs during processing of the OS 120, the OS 120 executes the caller function 31. When processing of the caller function 31 is carried out and, then, it is time to execute a call instruction to the debug target function 32 (call func_a), the debug target function 32 is called. In response, the debug target function 32 is executed. Once the processing of the debug target function 32 is completed, the caller function 31 receives, as a return value, a report of the processing result of the debug target function 32. Subsequently, the processing of the debug target function 32 is completed. Based on the return value received from the debag target function 32, the caller function 31 restarts its processing from an instruction following the call instruction to the debug target function 32.

Thus, in the case of not acquiring trace information, a call to the debug target function 32 is made during execution of the caller function 31. On the other hand, in the case of acquiring trace information, the content of the caller function 31 is rewritten in such a manner that a debug function is called during execution of the caller function 31.

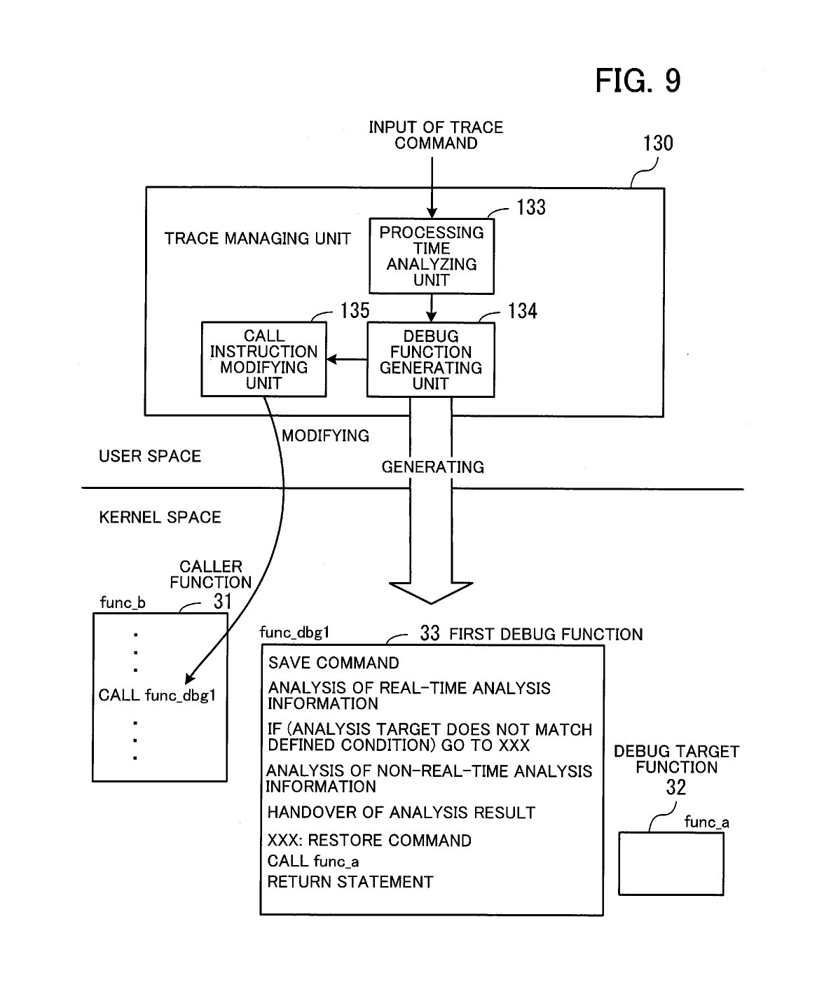

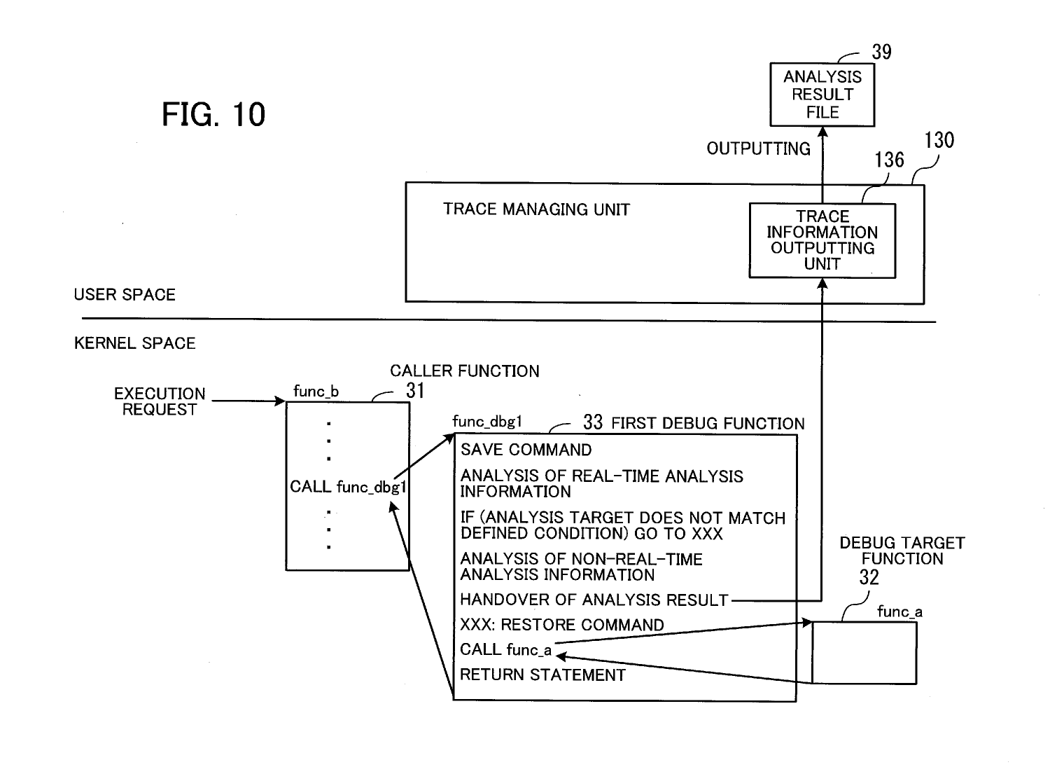

FIGS. 9 and 10 illustrate an example in which trace information is acquired by the first method. In the case of acquiring trace information by the first method, processing of the OS 120 at the start-up is the same as when no trace information is acquired. That is, as illustrated in FIG. 7, the caller function 112 and the debug target function 111 are loaded in the kernel space at the start-up of the OS 120. Subsequently, an instruction to execute a trace command is input, and in response, the processing time analyzing unit 133 of the trace managing unit 130 determines a trace information acquiring method having shorter response time. Assume here that the processing time analyzing unit 133 has determined that the first method has shorter response time.

FIG. 9 is a first diagram illustrating processing status for the case of acquiring trace information by the first method. In the case of acquiring trace information by the first method, the debug function generating unit 134 generates a first debug function 33 including processing for acquiring trace information by the first method. The generated first debug function 33 is loaded in the kernel space.

In addition, in the case of acquiring trace information by the first method, the call instruction modifying unit 135 rewrites content of a function call instruction in the caller function 31. For example, the call instruction modifying unit 135 rewrites the call instruction to the debug target function 32 (call func_a) in the caller function 31 loaded in the kernel space with a call instruction to the first debug function 33 (call func_dbg1).

FIG. 10 is a second diagram illustrating processing status for the case of acquiring trace information by the first method. Subsequently, when the OS 120 makes a request to execute the caller function 31, the caller function 31 is executed in the computer 100. When processing of the caller function 31 is carried out and, then, it is time to execute a call instruction to the first debug function 33 in the caller function 31, the first debug function 33 is called and executed in the computer 100. While the first debug function 33 is being executed, the caller function 31 waits for a return value.

The OS 120 carries out processing according to commands provided in the first debug function 33. For example, a save command is executed first. The save command is to collectively save, in the RAM 102, data stored in registers of the CPU 101. Executing the save command at the start when the first debag function 33 is called prevents data set in the registers by processing of the caller function 31 from being rewritten by processing of the call-target first debug function 33.

In addition, the OS 120 analyzes real-time analysis information according to the commands in the first debug function 33. Further, in the processing of the first debug function 33, non-real-time analysis information is analyzed if analysis-target data matches a defined condition set out in the request to execute the first debug function 33. The analysis result is handed over to the trace information outputting unit 136 of the trace managing unit 130. The defined condition is used to set information related to a call to the debug target function 32 as a target of the trace process. The information related to a function call includes, for example, a parameter of a corresponding function call statement and information in a memory area identified by an address assigned to the parameter. If the defined condition is not satisfied in the processing of the first debug function 33, analysis of non-real-time analysis information is not made and no analysis result is output.

The analysis result handed over to the trace information outputting unit 136 includes information designated as the analysis target. For example, in the processing of the first debug function 33, the analysis result is copied to a memory area managed by the trace managing unit 130. In this manner, handover of the analysis result is achieved.

Upon acquiring the analysis result from the first debug function 33, the trace information outputting unit 136 of the trace managing unit 130 writes the analysis result to, for example, an analysis result file 39. The analysis result file 39 is stored, for example, in the HDD 103.

In addition, in the processing of the first debug function 33, a restore command is executed after the completion of the trace process. The restore command is to collectively restore data of the registers saved by the save command. Subsequently, in the processing of the first debug function 33, a request to execute the debug target function 32 (a function call) is made. In response, the computer 100 executes the debug target function 32. While the debug target function 32 is being executed, the first debug function 33 waits for a return value.

Upon completion of the execution of the debug target function 32, the OS 120 uses the processing result of the debug target function 32 as a return value to the first debug function 33. Once acquiring the return value from the debug target function 32, the OS 120 returns to the processing of the first debug function 33 and uses the return value acquired from the debug target function 32 as a return value to the caller function 31. Subsequently, the processing of the first debug function 33 is completed. Based on the return value acquired from the first debug function 33, the OS 120 restarts the processing of the caller function 31 from a command following the function call instruction to the first debug function 33.

Note that the processing feature of the OS 120 based on the caller function 31 of FIGS. 9 and 10 is an example of the third process unit 6 according to the first embodiment of FIG. 3. In addition, the processing feature of the OS 120 based on the first debug function 33 of FIGS. 9 and 10 is an example of the first process unit 4 for the case of applying the first method according to the first embodiment of FIG. 3. Further, the processing feature of the OS 120 based on the debug target function 32 of FIGS. 9 and 10 is an example of the fourth process unit 7 according to the first embodiment of FIG. 3.

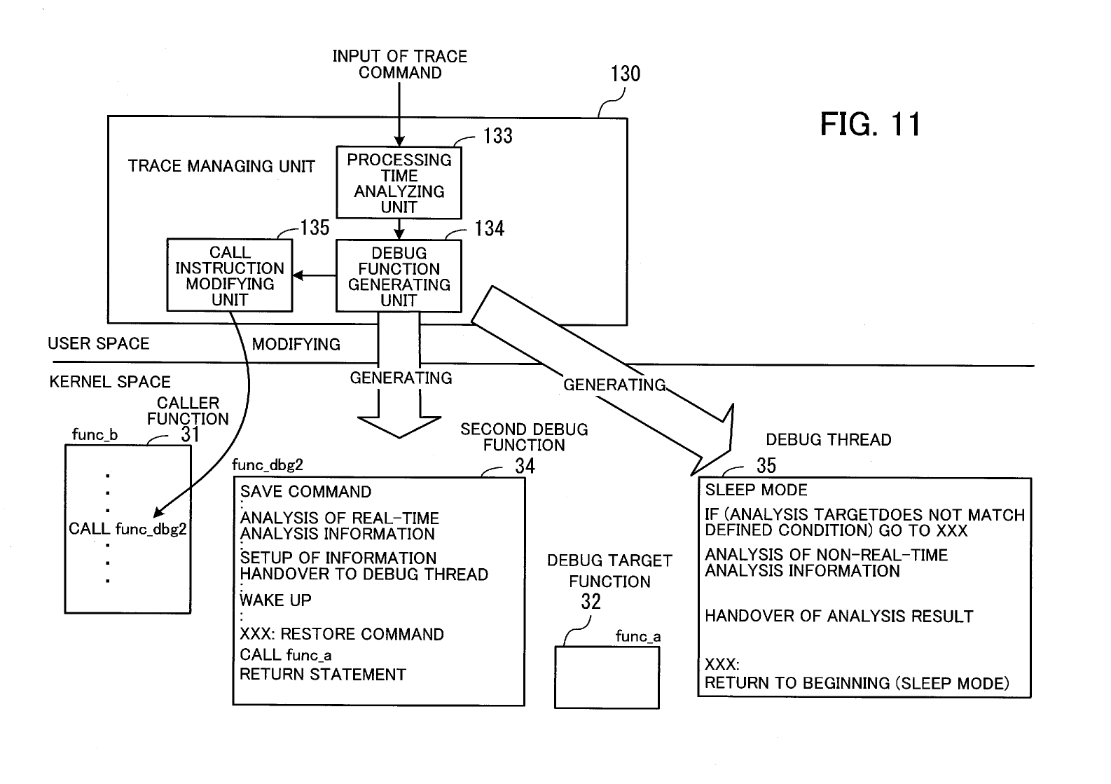

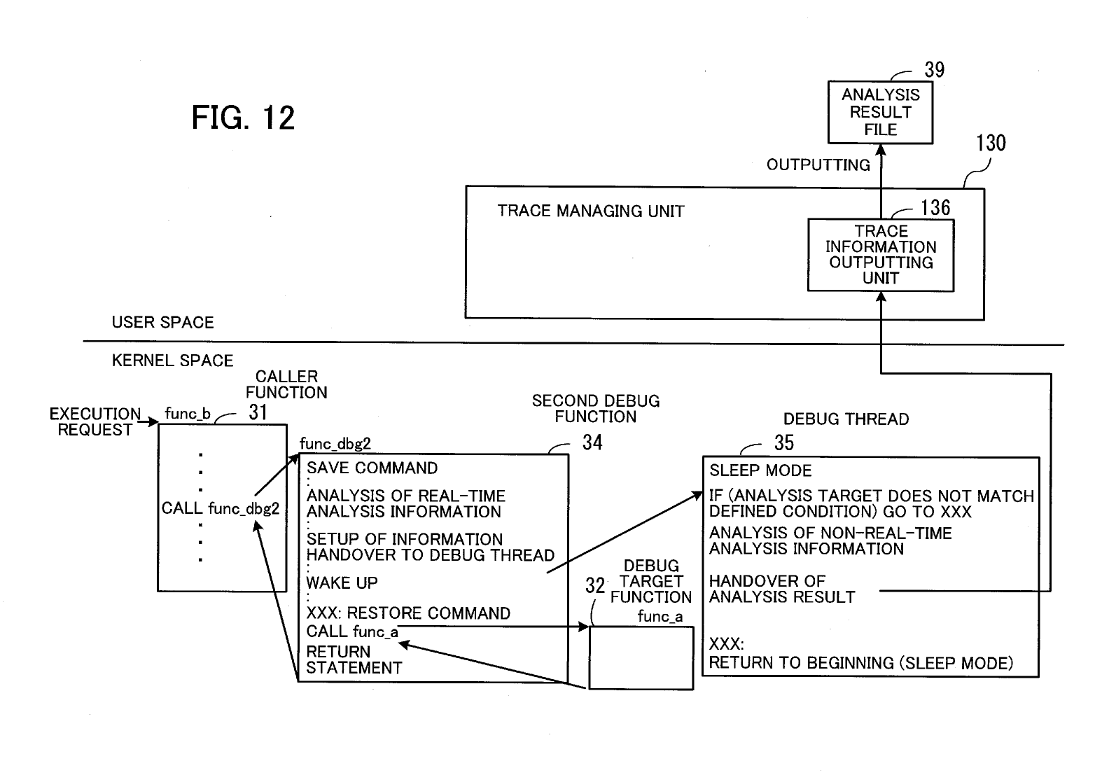

FIGS. 11 and 12 illustrate an example in which trace information is acquired by the second method. In the case of acquiring trace information by the second method, processing of the OS 120 at the start-up is the same as when no trace information is acquired. That is, as illustrated in FIG. 7, the caller function 112 and the debug target function 111 are loaded in the kernel space at the start-up of the OS 120. Subsequently, an instruction to execute a trace command is input, and in response, the processing time analyzing unit 133 of the trace managing unit 130 determines a trace information acquiring method having shorter response time. Assume here that the processing time analyzing unit 133 has determined that the second method has shorter response time.

FIG. 11 is a first diagram illustrating processing status for the case of acquiring trace information by the second method. In the case of acquiring trace information by the second method, the debug function generating unit 134 generates a second debug function 34 including processing for acquiring trace information by the second method. The generated second debug function 34 is loaded in the kernel space. In addition, the debug function generating unit 134 loads a program of a debug thread 35 in the kernel space. At this point, the debug thread 35 is in sleep mode. The debug thread 35 is a processing feature, the processing of which is executable in parallel with processing of the caller function 31, the debug target function 32, and the second debug function 34.

In addition, in the case of acquiring trace information by the second method, the call instruction modifying unit 135 rewrites content of a function call instruction in the caller function 31. For example, the call instruction modifying unit 135 rewrites the call instruction to the debug target function 32 (call func_a) in the caller function 31 loaded in the kernel space with a call instruction to the second debug function 34 (call func_dbg2).

FIG. 12 is a second diagram illustrating processing status for the case of acquiring trace information by the second method. Subsequently, when the OS 120 makes a request to execute the caller function 31, the caller function 31 is executed in the computer 100.

When processing of the caller function 31 is carried out and, then, it is time to execute a call instruction to the second debug function 34 in the caller function 31, the second debug function 34 is called and executed in the computer 100. While the second debug function 34 is being executed, the caller function 31 waits for a return value.

The OS 120 executes processing according to commands provided in the second debug function 34. For example, a save command is executed first. In addition, the OS 120 analyzes real-time analysis information according to the commands in the second debug function 34.

In addition, in the processing of the second debug function 34, a wake-up command to the debug thread is executed after information handover to the debug thread 35 is set up. This puts the debug thread 35 from sleep mode into operating mode. Subsequently, a restore command is executed, and then execution of the debug target function 32 is requested. In response, the computer 100 executes the debug target function 32. While the debug target function 32 is being executed, the second debug function 34 waits for a return value.

Upon completion of the execution of the debug target function 32, the OS 120 uses the processing result of the debug target function 32 as a return value to the second debug function 34. Once acquiring the return value from the debug target function 32, the OS 120 returns to the processing of the second debug function 34 and uses the return value acquired from the debug target function as a return value to the caller function 31. Subsequently, the processing of the second debug function 34 is completed. Based on the return value acquired from the second debug function 34, the OS 120 restarts the processing of the caller function 31 from a command following the function call instruction to the second debug function 34.

On the other hand, the debug thread 35 analyzes non-real-time analysis information and hands over the analysis result to the trace information outputting unit 136 of the trace managing unit 130 if analysis-target data matches a defined condition set out in the request to execute the second debug function 34. For example, the debug thread 35 copies the analysis result to a memory area managed by the trace managing unit 130. Note that if the defined condition is not satisfied, the debug thread 35 makes a transition to sleep mode without analyzing the non-real-time analysis information and outputting the analysis result.

Upon acquiring the analysis result from the debug thread 35, the trace information outputting unit 136 writes the analysis result to, for example, the analysis result file 39. The analysis result file 39 is stored, for example, in the HDD 103.

In the above-described manner, according to the second method, non-real-time analysis information is analyzed in the debug thread 35 executable in parallel with the processing of the second debug function 34. Therefore, the second debug function 34 executing the debug target function 32 moves forward with its own processing without waiting for the analysis of the non-real-time analysis information.

Note that the processing feature of the OS 120 based on the second debug function 34 of FIGS. 11 and 12 is an example of the first process unit 4 for the case of applying the second method according to the first embodiment of FIG. 3. In addition, the processing feature of the OS 120 using the debug thread 35 of FIGS. 11 and 12 is an example of the second process unit 5 according to the first embodiment of FIG. 3.

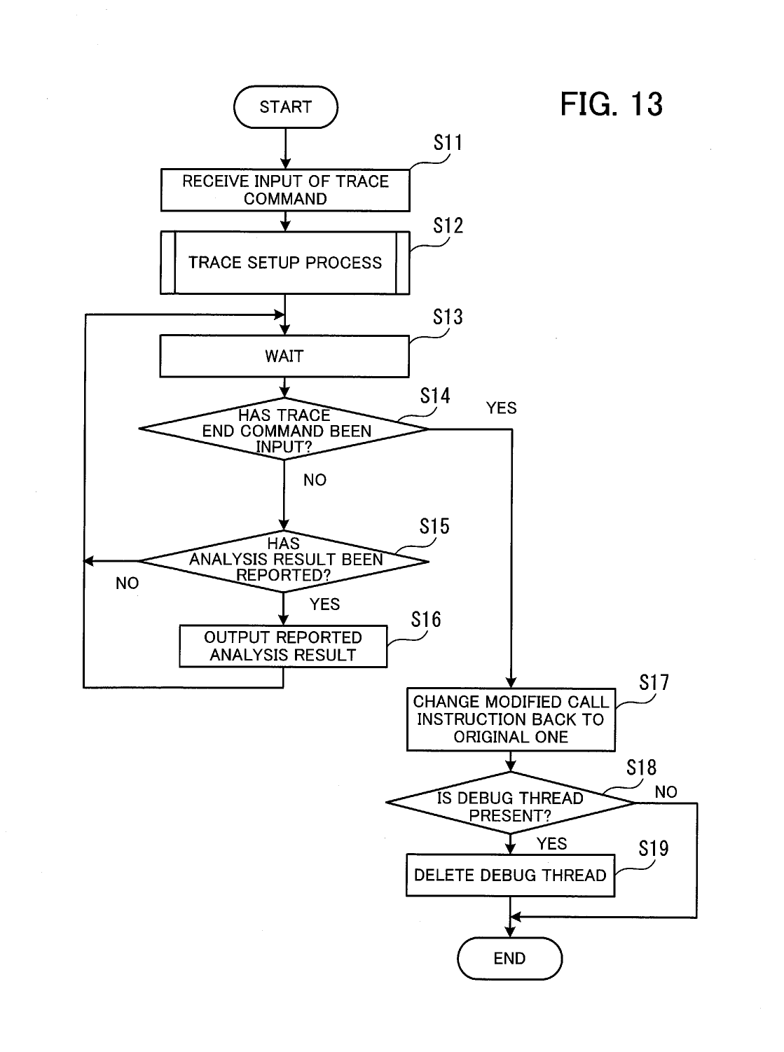

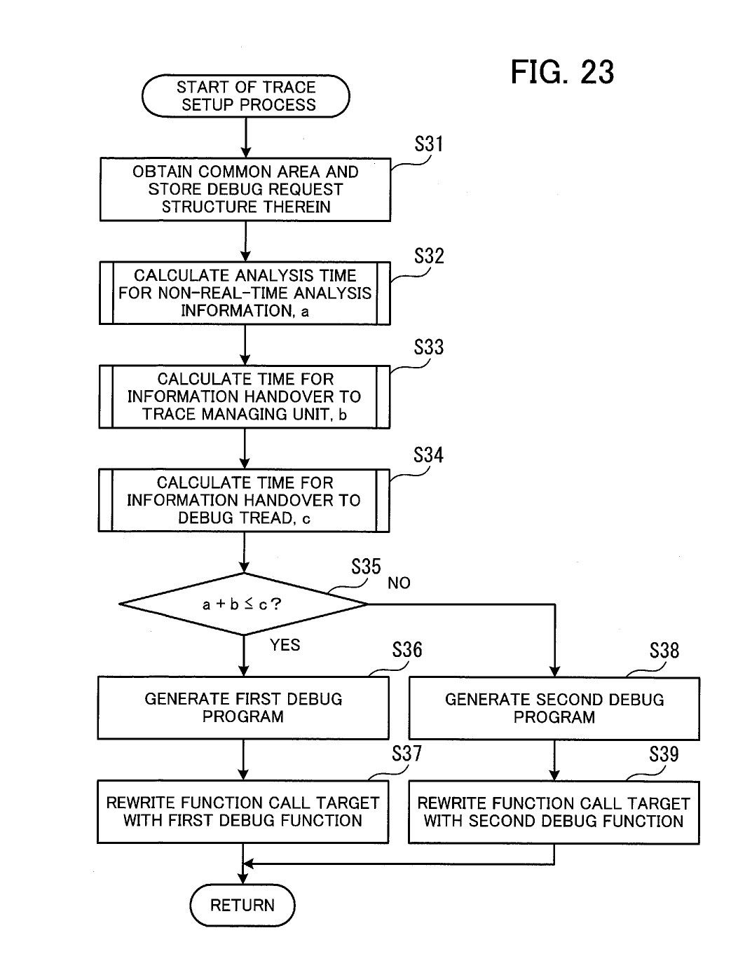

The following describes in detail a trace management process carried out by the trace managing unit 130. FIG. 13 is a flowchart illustrating a procedure of a trace management process. The process of FIG. 13 is described next according to the step numbers in the flowchart.

[Step S11] The OS 120 receives an input of a trace command. Upon receiving the trace command, the OS 120 starts the trace managing unit 130.

[Step S12] The trace managing unit 130 carries out a trace setup process. The trace setup process includes generating a debug program and modifying a function call instruction in a caller function. The trace setup process is described in detail later (see FIG. 23).

[Step S13] The trace information outputting unit 136 waits for a predetermined period of time, and then proceeds to step S14.

[Step S14] The trace information outputting unit 136 determines whether a trace end command has been input, for example, according to an administrator's operation. If a trace end command has been input, the trace information outputting unit 136 proceeds to step S17. If not, the trace information outputting unit 136 proceeds to step S15.

[Step S15] The trace information outputting unit 136 determines whether an analysis result has been reported. For example, the trace information outputting unit 136 determines affirmatively in the case where an analysis result is stored in a common area. If an analysis result has been reported, the trace information outputting unit 136 proceeds to step S16. If not, the trace information outputting unit 136 proceeds to step S13.

[Step S16] The trace information outputting unit 136 outputs the reported analysis result to, for example, a file, and then proceeds to step S13.

[Step S17] With respect to, in the caller function 31, a function call instruction modified in the trace setup process, the call instruction modifying unit 135 changes the modified function call instruction back to an original call instruction.

[Step S18] The debug function generating unit 134 determines the presence or absence of the debug thread 35. If the debug thread 35 is present, the debug function generating unit 134 proceeds to step S19. If not, the debug function generating unit 134 ends the trace management process.

[Step S19] The debug function generating unit 134 instructs the OS 120 to delete the debug thread 35, and subsequently ends the trace management process.

In the above-described manner, trace information is acquired.

Next described is an example of defining a trace condition based on the trace command input in step S11.

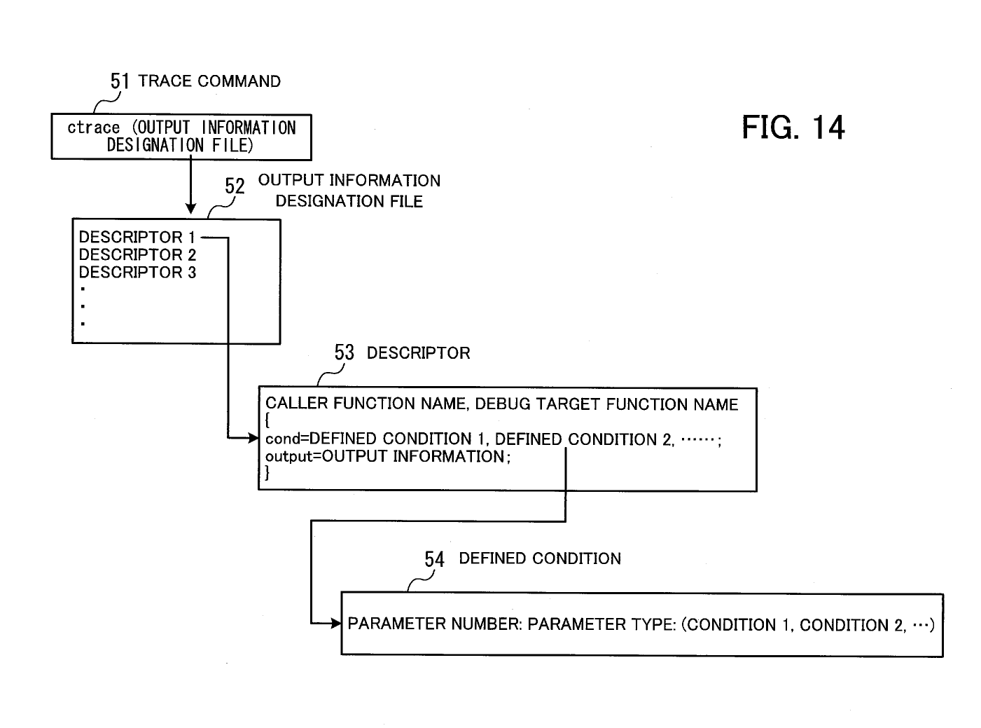

FIG. 14 illustrates an example of data formats of a trace command and an output information designation file.

A trace command 51 is input in the form of ‘ctrace (output information designation file)’, as illustrated in FIG. 14. Here, ‘ctrace’ is the command name of the trace command 51, and ‘output information designation file’ is a parameter set in the trace command 51. The ‘output information designation file’ contains a location (directory path) of a file (an output information designation file 52), in which a defined condition and the like for the trace process are set forth, and a name of the file.

In the output information designation file 52, for example, multiple descriptors are provided. In each descriptor 53, a caller function name, a debug target function name, one or more defined conditions, and output information are provided.

The caller function name is a name of a caller function to call the debug target function 111 targeted for debugging. Note that two or more caller functions may be designated. For example, in the case of designating three caller functions of ‘func_b1’, ‘func_b2’, and ‘func_b3’, the caller function name is expressed as ‘func_b1:func_b2:func_b3’. In addition, all functions to be executed in the kernel space may be designated as caller functions. In that case, for example, ‘kernel’ is set for the caller function name. On the other hand, only one debug target function name is designated in each descriptor 53 according to the second embodiment.

Each descriptor 53 may include multiple defined conditions. Each defined condition 54 includes a parameter number, a parameter type, and a selected number of conditions. The parameter number is designated, for example, by ‘argN (N=0, 1, 2, . . . )’. This indicates that the defined condition 54 is a condition entry for a parameter with a parameter number of ‘N’. The parameter type is designated by a keyword, such as ‘plain’ and ‘mblk_t’. The keyword ‘plain’ indicates that information set for the parameter is a beginning address of plain data (plain text). The keyword ‘mblk_t’ indicates that information set for the parameter is a beginning address of a message block structure.

Each condition is expressed, for example, in a form such as ‘A=B’ and ‘A<B’ (A and B are real numbers), or by a keyword such as ‘ftp’. For example, if ‘Ethertype=0x800’ is set as a condition when the parameter type is ‘mblk_t’, the defined condition 54 indicates that information is to be output only if ‘Ethertype’ of a packet indicated by the parameter is ‘0x800’ (i.e., only if the packet is an Internet Protocol (IP) packet). In addition, the defined condition 54 with a condition expressed as ‘pattern=“abc”’ indicates that information is to be output only if the packet includes a pattern “abc” (for example, 0x626364 in the hexadecimal format). The defined condition 54 with a condition expressed as ‘LEN<101’ indicates that information is to be output only if the packet length (including a Media Access Control (MAC) header) is shorter than 101 bytes. A condition expressed by the keyword ‘ftp’ has the same meaning of ‘Ethertype=0x800, protocol=tcp, port=21’, which in other words refers to a packet transmitted and received using the File Transfer Protocol (FTP).

The output information in the descriptor 53 is expressed by a keyword such as ‘argN (N=0, 1, 2, . . . )’, ‘timestamp’, and ‘stack’, or in a form such as ‘parameter number:parameter type:range’. The keyword ‘argN’ is a designation to output a value of the parameter number ‘N’. The keyword ‘timestamp’ is a designation to output the time when the debug target function was executed. The keyword ‘stack’ is a designation to output a stack of the debug target function. The form ‘parameter number:parameter type:range’ is a designation to output a part indicated by the ‘range’ out of information located at an address assigned to a parameter indicated by the ‘parameter number’, type of which information is indicated by the ‘parameter type’. The parameter number and the parameter type are designated in the same manner as those of the defined condition 54 above.

The range of the output information is designated in the form of, for example, ‘A-B’. Examples of designation of the range are: ‘0-64’ which indicates to output a part located from the 0^{th} to 64^{th} byte of the packet; ‘0-IP_header’ which indicates to output a part located from the 0^{th} byte to the end of the IP header of the packet; ‘14-64’ which indicates to output a part located from the 14^{th} to 64^{th} byte of the packet; and ‘0-end’ which indicates to output the entire packet.

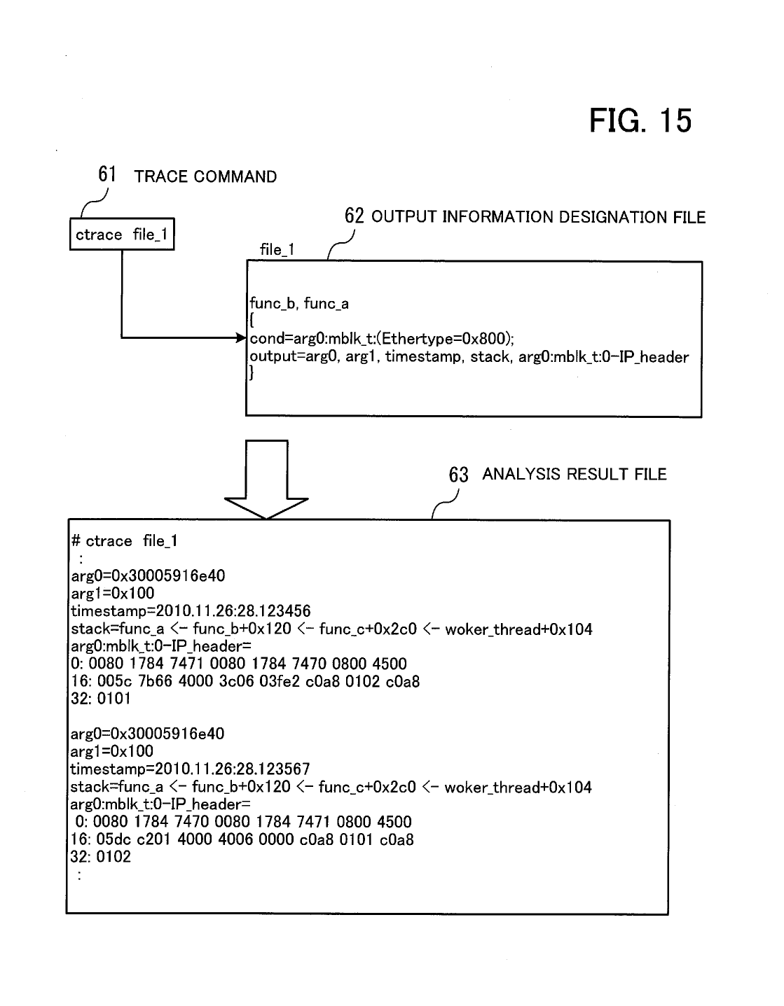

FIG. 15 illustrates a first example of an output result according to a trace command and an output information designation file. In the example of FIG. 15, an output information designation file 62 with a file name ‘file_{—}1’ is designated in a trace command 61.

According to the example of the output information designation file 62, a process of acquiring trace information (hereinafter, the ‘trace information acquiring process’) is carried out each time a function ‘func_a’ is called by the caller function 31 which executes a program corresponding to the function ‘func_b’. In the trace information acquiring process, in the case where Parameter of the function ‘func_a’ indicates packet information transferred through a network, information is output only if ‘Ethertype’ is ‘0x800’ (i.e., only if the packet is an IP packet). The output information includes a value of Parameter 0; a value of Parameter 1; a time stamp; a stack; and a part located from the 0^{th} byte to the end of the IP header of the packet. As for the analysis result, the content of an analysis result file 63 of FIG. 15, for example, is output.

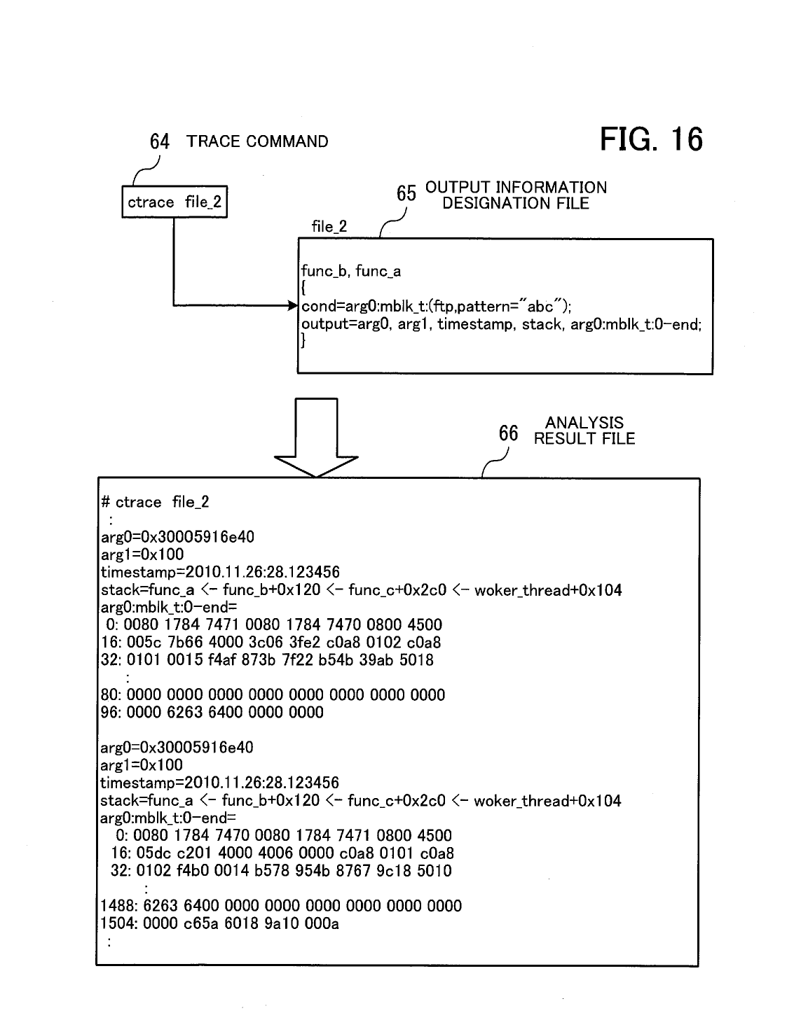

FIG. 16 illustrates a second example of an output result according to a trace command and an output information designation file. In the example of FIG. 16, an output information designation file 65 with a file name ‘file_{—}2’ is designated in a trace command 64. According to the example of the output information designation file 65, the trace information acquiring process is carried out each time the function ‘func_a’ is called by the caller function 31 which executes a program corresponding to the function ‘func_b’. In the trace information acquiring process, in the case where Parameter of the function ‘func_a’ is packet information transferred through a network, information is output only if the packet is an FTP packet and includes the pattern of ‘abc’. The output information includes a value of Parameter 0; a value of Parameter 1; a time stamp; a stack; and the entire packet. As for the analysis result, the content of an analysis result file 66 of FIG. 16, for example, is output.

In the above-described manner, preparing output information designation files in advance allows detailed designations of conditions related to output information. The trace managing unit 130 hands over conditions for output information set out in an output information designation file to the first debug function 33 or the second debug function 34 in the kernel space, for example, via a common area. The common area is a memory area in the kernel space, accessible by both processes in the kernel space and those in the user space.

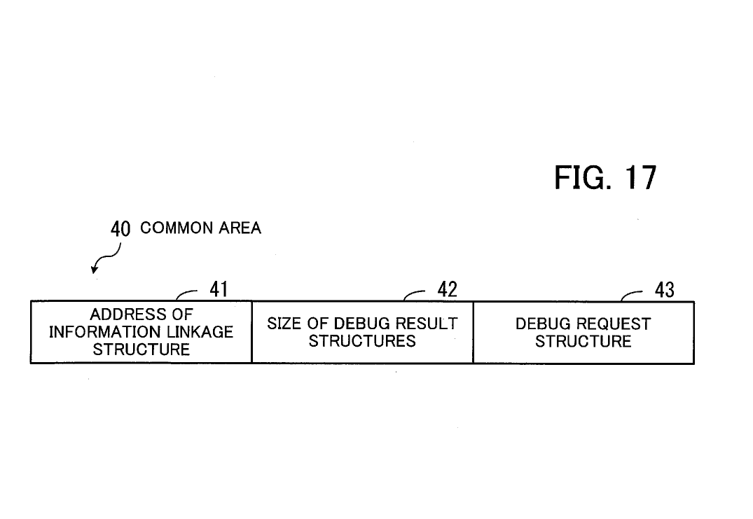

FIG. 17 illustrates an example of a data configuration of a common area. In a common area 40, for example, three fields 41 to 43 are provided. The first field 41 contains an address of an information linkage structure. Information linkage structures are information to sequentially associate analysis results of multiple function calls made by multiple callers to a trace-target function. The address set in the first field 41 of the common area 40 is an address of a first one of information linkage structures in a linked relationship. The second field 42 contains a size of debug result structures. The debug result structures are storage areas for analysis results obtained by debugging. The third field 43 contains a debug request structure. The debug request structure is information indicating content of a debug request from the trace managing unit 130. Note that the debug request structure is generated by the debug function generating unit 134 based on an output information designation file designated in a trace command.

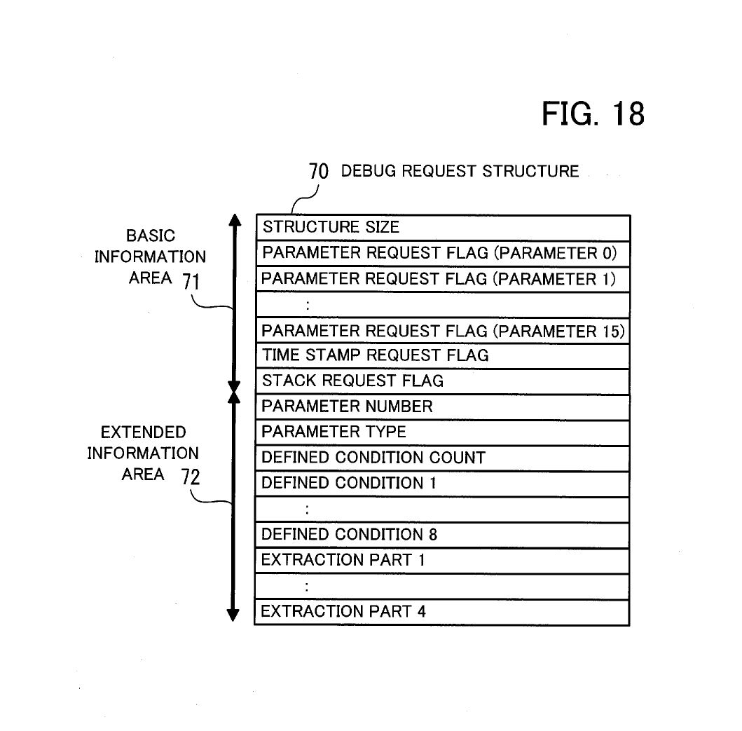

FIG. 18 illustrates an example of a data configuration of a debug request structure. A debug request structure 70 includes a basic information area 71 and an extended information area 72. The basic information area 71 includes fields for structure size; parameter request flags for individual parameters; time stamp request flag; and stack request flag.

The field for ‘structure size’ contains the data size of the debug request structure 70.

Each field for ‘parameter request flag’ contains a flag to indicate whether to output a value of a corresponding parameter included in the function call instruction. The example of FIG. 18 assumes the case where up to sixteen parameters are set for the function call instruction. As for the parameters set for the function call instruction, for example, parameter numbers of 0 to 15 are sequentially assigned to the parameters from the left. In the case of not outputting a value of a parameter corresponding to each parameter number, for example, ‘0’ is set in a field for ‘parameter request flag’, corresponding to the parameter number. On the other hand, ‘1’ is set in the field to output a value of the parameter.

The field for ‘time stamp request flag’ contains a flag to indicate whether to output a time stamp. In the case of not outputting a time stamp, for example, ‘0’ is set in the field. On the other hand, ‘1’ is set in the field to output a time stamp indicating the time of execution of a function call instruction by the caller function 31.

The field for ‘stack request flag’ contains a flag to indicate whether to output stack information. In the case of not outputting stack information, for example, ‘0’ is set in the field. On the other hand, ‘1’ is set in the field to output stack information.

The extended information area 72 includes fields for parameter number; parameter type; defined condition count; multiple defined conditions; and multiple extraction parts.

The field for ‘parameter number’ contains a number of a parameter to which an address of a memory area storing therein information to be output has been assigned.

The field for ‘parameter type’ contains a type of the information to be output. For example, if the information to be output is a message block structure representing data transmitted and received through a network, ‘1’ is set in the field. On the other hand, ‘2’ is set in the field if the information to be output is a plain data file.

The field for ‘defined condition count’ contains the number of defined conditions.

Each of the fields for ‘defined conditions’ contains a defined condition used as a criterion for determining whether to output the information. For example, in the case where ‘1’ is set in the field for ‘parameter type’, conditions regarding ‘Ethertype’, ‘transmission source and destination IP addresses’, ‘packet length’ and the like are set in the fields for ‘defined conditions’.

Each of the fields for ‘extraction parts’ contains information designating a part to be extracted as an analysis result from the information to be output. For example, in the case where ‘1’ is set in the field for ‘parameter type’, the following parts may be designated as parts to be extracted: from the beginning to MAC header; the beginning to IP header; from the beginning to TCP header; IP header only; TCP header only; TCP checksum value only; and from the xx^{th} to yy^{th} byte.

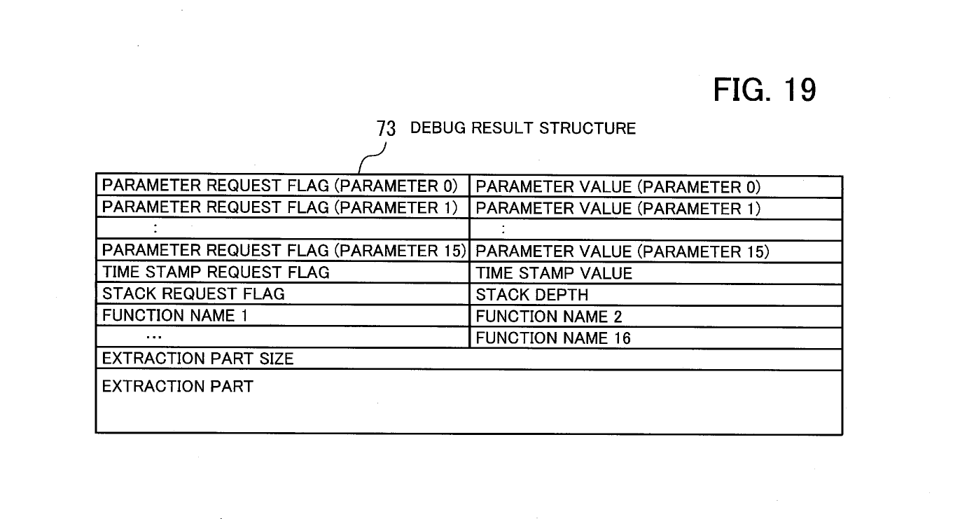

FIG. 19 illustrates an example of a data configuration of a debug result structure. A debug result structure 73 includes fields for parameter request flags for individual parameter numbers and fields for parameter values corresponding to the individual fields for parameter request flags. Each of the fields for ‘parameter request flags’ contains a flag indicating whether a parameter identified by its corresponding parameter number has been acquired. Each of the fields for ‘parameter values’ contains a value of a parameter identified by its corresponding parameter number.

The debug result structure 73 also includes fields for time stamp request flag; and time stamp value. The field for ‘time stamp request flag’ contains a flag indicating whether a time stamp has been acquired. The field for ‘time stamp value’ contains a value of the acquired time stamp.

Further, the debug result structure 73 includes fields for stack request flag; stack depth; and function names in a stack. The field for ‘stack request flag’ contains a flag indicating whether a stack has been acquired. The field for ‘stack depth’ contains a value indicating how many levels of function calls have been made (i.e., the number of function names included in the stack). The fields for ‘function names’ contain the function names included in the stack. For example, sequential numbers are assigned to the fields for ‘function names’, and the function names are set in the fields for ‘function names’ in sequential order of functions, starting from a function of a first caller.

Further, the debug result structure 73 includes fields for extraction part size; and extraction part. The field for ‘extraction part size’ contains a size of partial data extracted from information stored in a memory area identified by an address assigned to each parameter. The field for ‘extraction part’ contains the extracted partial data.

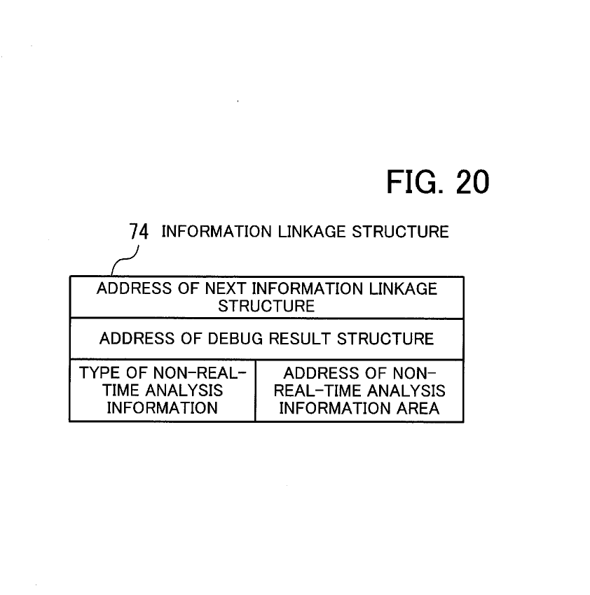

FIG. 20 illustrates an example of a data configuration of an information linkage structure. An information linkage structure 74 includes fields for address of next information linkage structure; address of debug result structure; type of non-real-time analysis information; and address of non-real-time analysis information area. The field for ‘address of next information linkage structure’ contains a beginning address of a memory area storing therein an information linkage structure linked next. Note that if there is no next linked information linkage structure, ‘0’ is set in the field, for example. The field for ‘address of debug result structure’ contains a beginning address of a memory area storing therein a debug result structure. The field for ‘type of non-real-time analysis information’ contains a type of data configuration of a memory area storing therein non-real-time analysis information. For example, in the case where the data configuration of the non-real-time analysis information is a message block structure, ‘1’ is set in the field. On the other hand, ‘2’ is set in the field if the data configuration is plain data. The field for ‘address of non-real-time analysis information area’ contains a beginning address of the memory area storing therein the non-real-time analysis information. A linked relationship is defined by multiple information linkage structures 74 of FIG. 20.

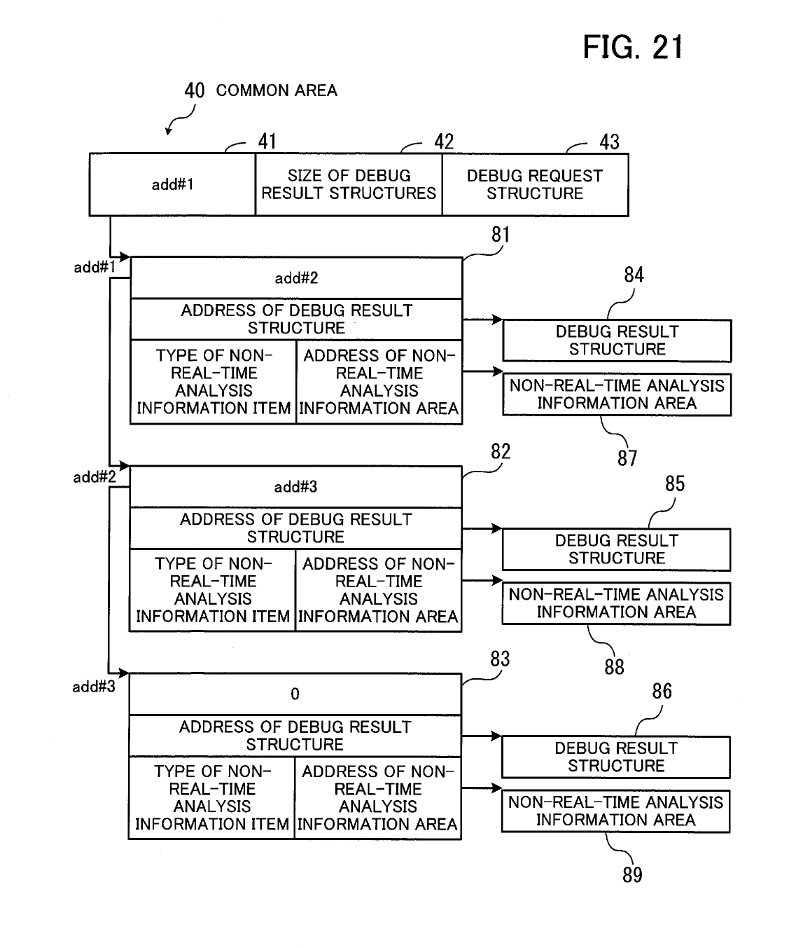

FIG. 21 illustrates an example of a linked relationship of information linkage structures. In the example of FIG. 21, three information linkage structures 81 to 83 are in a linked relationship. In the common area 40, the field 41 for ‘address of information linkage structure’ contains a beginning address of a memory area storing therein the information linkage structure 81. The field for ‘address of next information linkage structure’ of the information linkage structure 81 contains a beginning address of a memory area storing therein the information linkage structure 82. Similarly, the field for ‘address of next information linkage structure’ of the information linkage structure 82 contains a beginning address of a memory area storing therein the information linkage structure 83. The field for ‘address of next information linkage structure’ of the information linkage structure 83 contains a value of ‘0’ indicating that the information linkage structure 83 is located at the end of the linkage.

The addresses in the fields for ‘address of debug result structure’ of the individual information linkage structures 81 to 83 associate the information linkage structures 81 to 83 with debug result structures 84 to 86, respectively. In addition, the addresses in the fields for ‘address of non-real-time analysis information area’ of the individual information linkage structures 81 to 83 associate the information linkage structures 81 to with memory areas including non-real-time analysis information (non-real-time analysis information areas) 87 to 89, respectively.

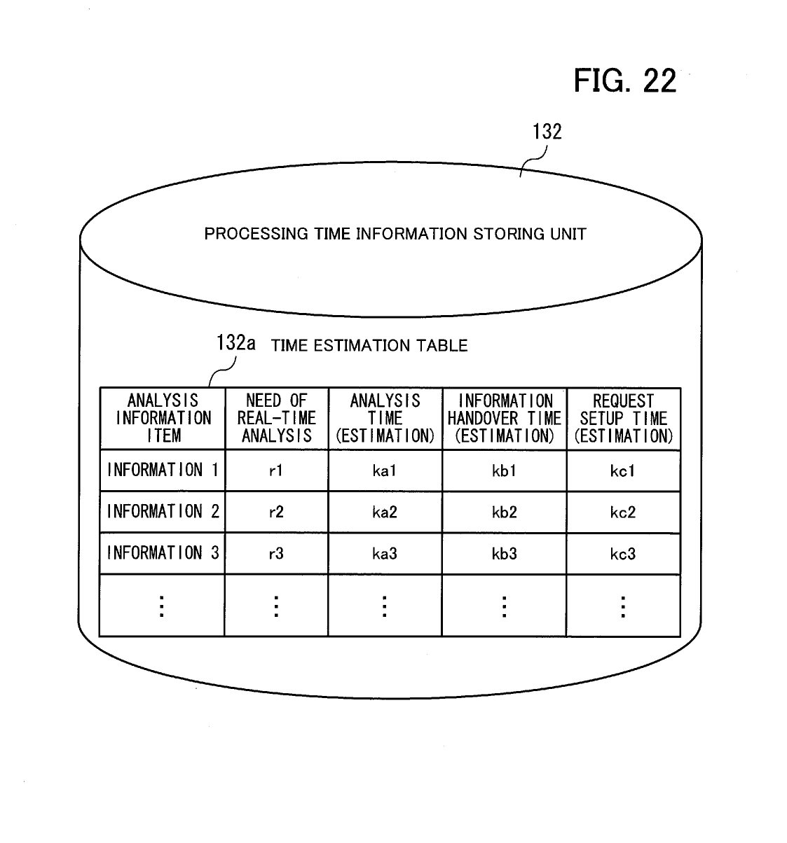

Next described is a data configuration of the processing time information storing unit 132. FIG. 22 illustrates an example of a data configuration of a processing time information storing unit. The processing time information storing unit 132 stores therein a time estimation table 132a. The time estimation table 132a includes columns for analysis information item; need of real-time analysis; analysis time; information handover time; and request setup time.

Each entry in the column for ‘analysis information item’ is a type of information to be analyzed in the trace process. The analysis information items include information allowed to be designated as output targets by an output information designation file (output information) and information to be checked against defined conditions. Each entry in the column for ‘need of real-time analysis’ indicates whether a corresponding analysis information item is to be analyzed in real time. Each entry in the column for ‘analysis time’ is estimated time to analyze a corresponding analysis information item. Each entry in the column for ‘information handover time’ is estimated time to hand over, to the trace managing unit 130, trace information obtained for a corresponding analysis information item as an analysis result. Each entry in the column for ‘request setup time’ is time estimated for a setup process for requesting the debug thread 35 to analyze non-real-time analysis information.

The time estimation table 132a allows proper determination on selecting a trace acquisition method from between the first and the second method in the trace setup process (Step S12 of FIG. 13).

FIG. 23 is a flowchart illustrating a procedure of a trace setup process. The process of FIG. 23 is described next according to the step numbers in the flowchart.

[Step S31] The debug function generating unit 134 of the trace managing unit 130 obtains the common area in the kernel space. Next, the debug function generating unit 134 generates a debug request structure according to content of an output information designation file designated by the parameter of the trace command.

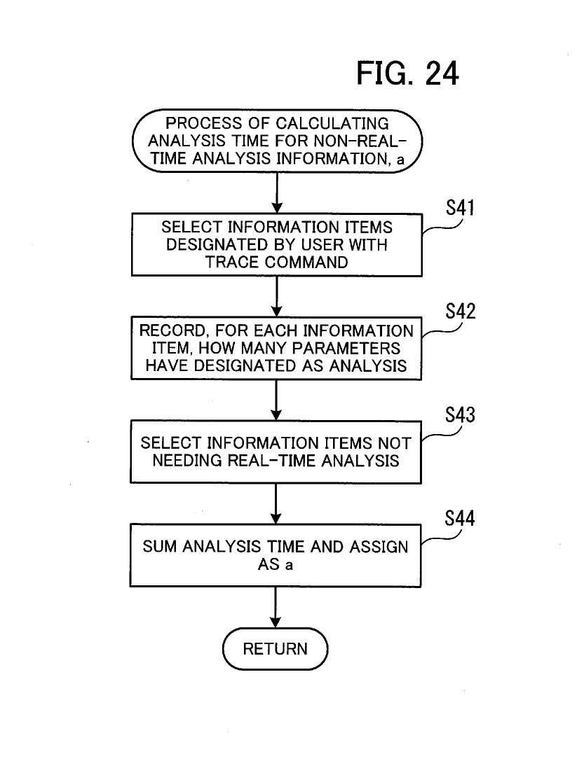

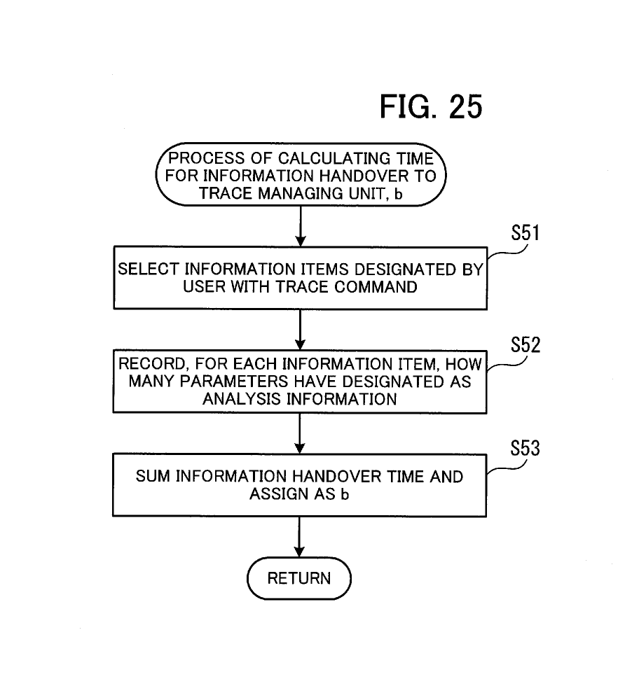

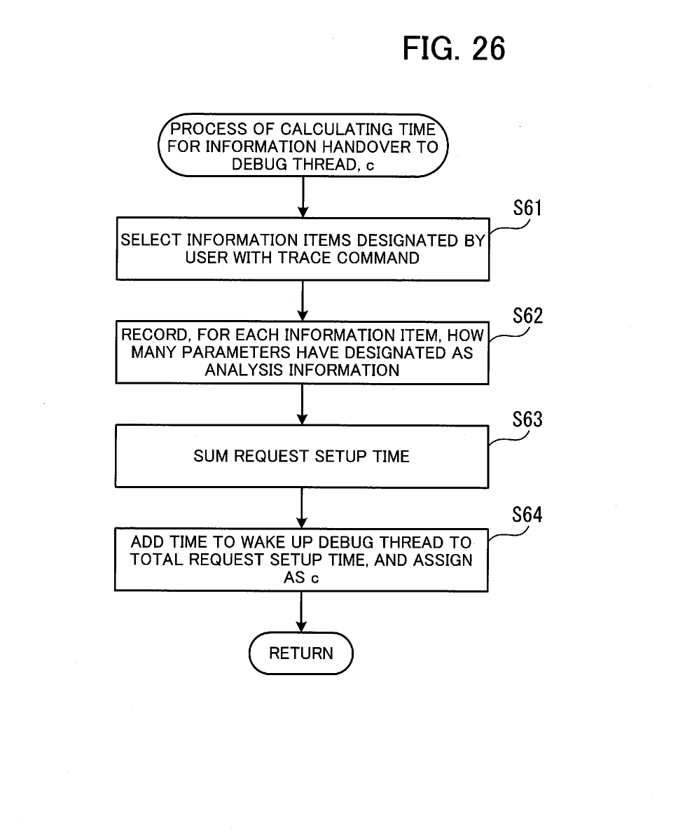

Then, the debug function generating unit 134 stores the generated debug request structure in the common area 40. In addition, the debug function generating unit 134 calculates the size of debug result structures, which is then stored in the common area 40.

[Step S32] The processing time analyzing unit 133 carries out a process of calculating analysis time for non-real-time analysis information. At this point, the calculated analysis time for non-real-time analysis information is assigned as Variable a. This process is described in detail later (see FIG. 24).

[Step S33] The processing time analyzing unit 133 carries out a process of calculating time for information handover to the trace managing unit 130. At this point, the calculated information handover time is assigned as Variable b. This process is described in detail later (see FIG. 25).

[Step S34] The processing time analyzing unit 133 carries out a process of calculating time for information handover to the debug thread 35. At this point, the calculated information handover time is assigned as Variable c. This process is described in detail later (see FIG. 26).

[Step S35] The processing time analyzing unit 133 determines which one of the first method and the second method is appropriate as the trace acquisition method. For example, the processing time analyzing unit 133 compares time obtained by adding the analysis time for the non-real-time analysis information (a) to the time for information handover to the trace managing unit 130 (b) against the time for information handover to the debug thread 35 (c). If the times are equal to each other, or the time for information handover to the debug thread 35 (c) is longer, the processing time analyzing unit 133 determines that the first method is appropriate and then proceeds to step S36. If the time obtained by the addition (a+b) is longer, the processing time analyzing unit 133 determines that the second method is appropriate and then proceeds to step S38.

[Step S36] When the processing time analyzing unit 133 determines that the first method is appropriate, the debug function generating unit 134 generates the first debug function 33 with the function name ‘func_dbg1’. The debug function generating unit 134 loads the generated first debug function 33 in the kernel space. Then, the debug function generating unit 134 configures settings on the OS 120 in such a manner that the generated first debug function 33 is executed in response to a call with the function name ‘func_dbg1’.

[Step S37] The call instruction modifying unit 135 changes a function call target in the caller function 31 to the first debug function 33. For example, in the kernel space, the call instruction modifying unit 135 rewrites the call instruction to the debug target function 32 in the caller function 31 with a call instruction to the first debug function 33. Subsequently, the trace setup process is ended.

[Step S38] When the processing time analyzing unit 133 determines that the second method is appropriate, the debug function generating unit 134 generates the second debug function 34 with the function name ‘func_dbg2’. The debug function generating unit 134 loads the generated second debug function 34 in the kernel space. Then, the debug function generating unit 134 configures settings on the OS 120 in such a manner that the generated second debug function 34 is executed in response to a call with the function name ‘func_dbg2’.

[Step S39] The call instruction modifying unit 135 changes a function call target in the caller function 31 to the second debug function 34. For example, in the kernel space, the call instruction modifying unit 135 rewrites the call instruction to the debug target function 32 in the caller function 31 with a call instruction to the second debug function 34. Subsequently, the trace setup process is ended.

Next described is a procedure of calculating analysis time for the non-real-time analysis information.

FIG. 24 is a flowchart illustrating a procedure example for calculating analysis time for non-real-time analysis information. The process of FIG. 24 is described next according to the step numbers in the flowchart.

[Step S41] The processing time analyzing unit 133 checks, in the column for ‘analysis information item’ of the time estimation table 132a, entries designated by a user with a trace command, and selects rows corresponding to all the designated analysis information items. For example, with reference to the basic information area 71 of the debug request structure 70 stored in the common area 40, the processing time analyzing unit 133 determines a parameter number of each parameter corresponding to a parameter request flag indicating that information of the parameter is to be output (the value of the flag being ‘1’, for example). Next, based on a parameter description format of the trace target function (func_a), the processing time analyzing unit 133 determines information items corresponding to parameters, the information of which is to be output. Subsequently, the processing time analyzing unit 133 selects, from the time estimation table 132a, rows corresponding to all the information items being targets of information output. In addition, with reference to the extended information area 72 of the debug request structure 70, the processing time analyzing unit 133 selects, from the time estimation table 132a, all rows corresponding to information to be checked against defined conditions and information designated as parts to be extracted.

[Step S42] With respect to an information item of each of the selected rows, the processing time analyzing unit 133 counts the number of parameters that have designated the information item as analysis information, and stores the number in, for example, the RAM 102.

[Step S43] The processing time analyzing unit 133 selects, among from the information items of the rows selected in step S41, information not needing real-time analysis. For example, the processing time analyzing unit 133 refers to, in the column for ‘need of real-time analysis’ of the time estimation table 132a, entries corresponding to the rows selected in step S41, and selects all rows whose entries indicate no need of real-time analysis.

[Step S44] The processing time analyzing unit 133 sums analysis time of the rows selected in step S43, and assigns the total analysis time as Variable a. Note that, as for each information item designated by multiple parameters as analysis information, the processing time analyzing unit 133 multiplies the analysis time of the information item by the number of the multiple parameters before the summation.

In the above-described manner, the analysis time for non-real-time analysis information is calculated.

Next described is a procedure for calculating time for information handover to the trace managing unit 130. FIG. 25 is a flowchart illustrating a procedure example for calculating time for information handover to a trace managing unit. The process of FIG. 25 is described next according to the step numbers in the flowchart.

[Step S51] The processing time analyzing unit 133 checks, in the column for ‘analysis information item’ of the time estimation table 132a, entries designated by the user with the trace command, and selects rows corresponding to all the designated analysis information items. Details on this processing step are the same as those of step S41 of FIG. 24.

[Step S52] With respect to an information item of each of the selected rows, the processing time analyzing unit 133 counts the number of parameters that have designated the information item as analysis information, and stores the number in, for example, the RAM 102.

[Step S53] The processing time analyzing unit 133 sums information handover time of the rows selected in step S51, and assigns the total information handover time as Variable b. Note that, as for each information item designated by multiple parameters as analysis information, the processing time analyzing unit 133 multiplies the information handover time of the information item by the number of the multiple parameters before the summation.

In the above-described manner, the time for information handover to the trace managing unit 130 is calculated.

Next described is a procedure for calculating time for information handover to the debug thread 35. FIG. 26 is a flowchart illustrating a procedure example for calculating time for information handover to a debug thread. The process of FIG. 26 is described next according to the step numbers in the flowchart.

[Step S61] The processing time analyzing unit 133 checks, in the column for ‘analysis information item’ of the time estimation table 132a, entries designated by the user with the trace command, and selects rows corresponding to all the designated analysis information items. Details on this processing step are the same as those of step S41 of FIG. 24.

[Step S62] With respect to an information item of each of the selected rows, the processing time analyzing unit 133 counts the number of parameters that have designated the information item as analysis information, and stores the number in, for example, the RAM 102.

[Step S63] The processing time analyzing unit 133 sums request setup time of the rows selected in step S61. Note that, as for each information item designated by multiple parameters as analysis information, the processing time analyzing unit 133 multiplies the information handover time of the information item by the number of the multiple parameters before the summation.

[Step S64] The processing time analyzing unit 133 adds time to wake up the debug thread 35 to the total time calculated in step S63, and assigns the added up time as Variable c. Note that the time to wake up the debug thread 35 is preliminarily set, for example, in the processing time analyzing unit 133.

In the above-described manner, the time for information handover to the debug thread 35 is calculated.

An applicable trace acquisition method is determined based on the time to analyze non-real-time analysis information, the time for information handover to the trace managing unit 130, and the time for information handover to the debug thread 35 calculated in the above-described manner. The following describes a specific calculation example.

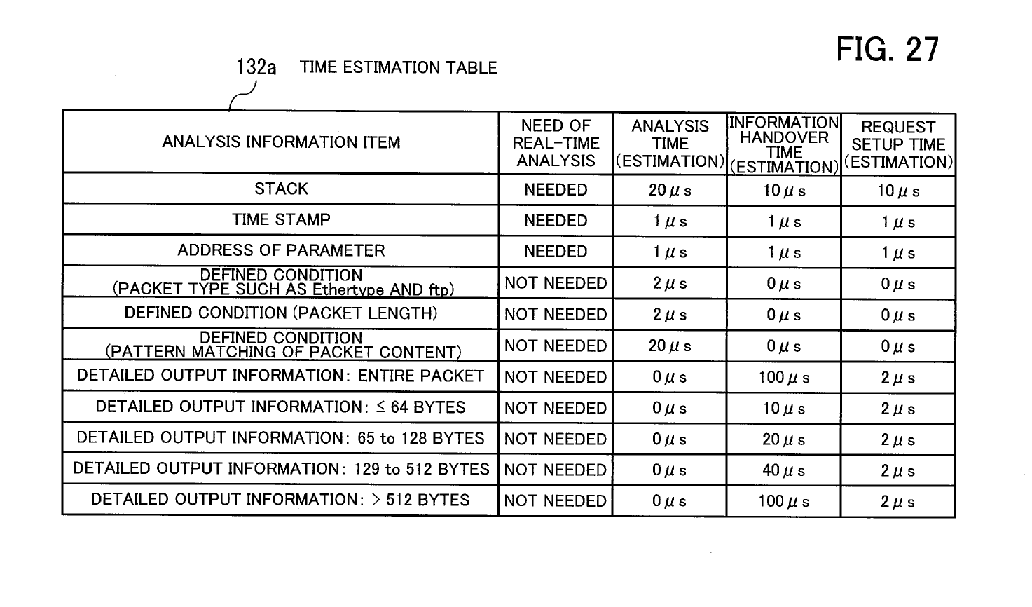

FIG. 27 illustrates an example of information provided in a time estimation table. In the example of the time estimation table 132a of FIG. 27, individual entries in the columns for ‘analysis time’, ‘information handover time’, and ‘request setup time’ contain time in microseconds (μs). In addition, the analysis time, the information handover time, and the request setup time corresponding to each entry in the column for ‘analysis information item’ are, for example, values actually measured in a predetermined environment. Assume here that the time to wake up a debug thread is 10 μs, which is not included in FIG. 27.

The following describes two examples of determining an applicable trace acquisition method based on the time estimation table 132a of FIG. 27.

<First Example of Determining Trace Acquisition Method>

Assume in the first example that a trace command designates output of a stack, a time stamp, an address assigned to Parameter 0, and an address assigned to Parameter 1. The time to analyze no-real-time analysis information, the time for information handover to the trace managing unit 130, and the time for information handover to the debug thread 35 in this case are calculated in the following manner.

The time to analyze no-real-time analysis information (Variable a) is 0 μs. This is because all the analysis information items designated by the trace command need to be analyzed in real time.

The time for information handover to the trace managing unit 130 (Variable b) is 13 μs, which is obtained by: 10 μs (time to hand over a stack)+1 μs (time to hand over a time stamp)+1 μs×2 (time to hand over a parameter×2 parameters).

The time for information handover to the debug thread 35 (Variable c) is 23 μs, which is obtained by: 10 μs (time to hand over a stack)+1 μs (time to hand over a time stamp)+1 μs×2 (time to hand over a parameter×2 parameters)+10 μs (time to wake up a debug thread).

In this case, since a+b=0+13=13 μs while c=23 μs, the determination of ‘a+b c’ in step S35 of FIG. 23 is YES. As a result, the first method is determined to be applicable.

<Second Example of Determining Trace Acquisition Method>

Assume in the second example that the beginning address of a message block structure is assigned to Parameter 1, and that a trace command designates output of a stack, a time stamp, an address assigned to Parameter 0, an address assigned to Parameter 1, and an entire packet indicated by Parameter 1, ‘Ethertype’ of which is ‘0x800’. The time to analyze no-real-time analysis information, the time for information handover to the trace managing unit 130, and the time for information handover to the debug thread 35 in this case are calculated in the following manner.

The time to analyze no-real-time analysis information (Variable a) is 2 μs (analysis time for Ethertype=0x800).

The time for information handover to the trace managing unit 130 (Variable b) is 113 μs, which is obtained by: 10 μs (time to hand over a stack)+1 μs (time to hand over a time stamp)+1 μs×2 (time to hand over a parameter×2 parameters)+100 μs (time to hand over an entire packet).

The time for information handover to the debug thread 35 (Variable c) is 25 μs, which is obtained by: 10 μs (time to hand over a stack)+1 μs (time to hand over a time stamp)+1 μs×2 (time to hand over a parameter×2 parameters)+2 μs (time to hand over an entire packet)+10 μs (time to wake up a debug thread).

In this case, since a+b=2+113=115 μs while c=25 μs, the determination of ‘a+b c’ in step S35 of FIG. 23 is NO. As a result, the second method is determined to be applicable.

In the above-described manner, a method resulting in shorter time for a program executing the debug process to respond to a caller program is selected from between the first method and the second method, and then the debug process including the trace process is executed by the selected method. The following describes in detail a procedure of the debug process.

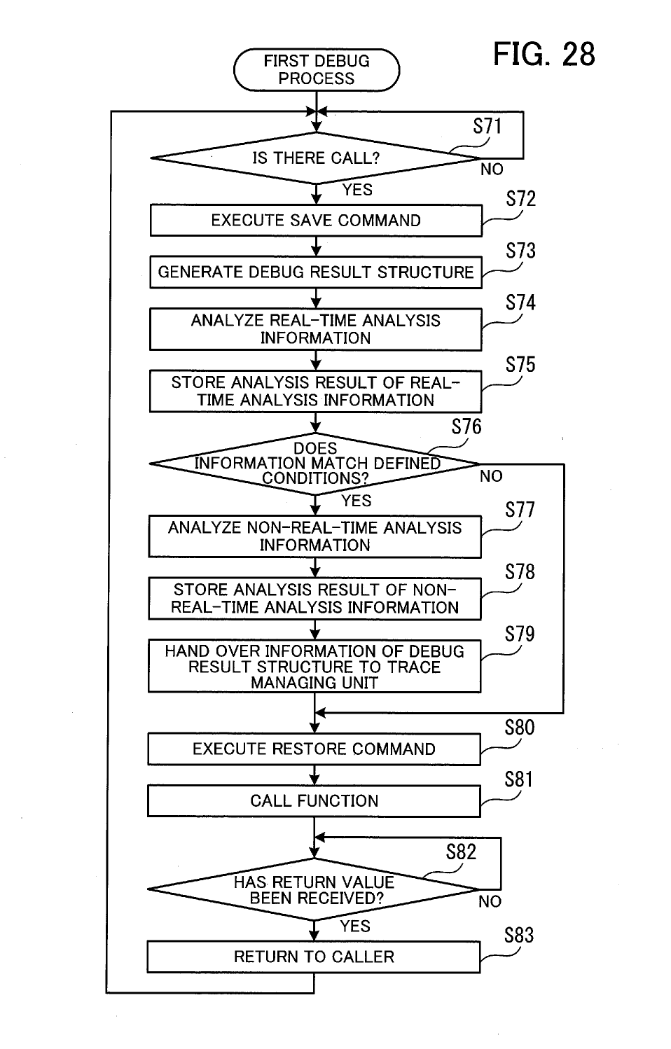

First described is a first debug process executing the trace process by the first method. FIG. 28 is a flowchart illustrating a procedure example of a first debug process. The process of FIG. 28 is described next according to the step numbers in the flowchart. The process of FIG. 28 is carried out by the computer 100 based on instructions set out in the first debug function 33.

[Step S71] The OS 120 determines whether there is a call to the first debug function 33 from the caller function 31. If there is a call to the first debug function 33, the OS 120 starts the first debug function 33 and then proceeds to step S72. If not, the OS 120 repeats step S71.

[Step S72] The OS 120 executes a save command to save content of the registers in the RAM 102.

[Step S73] The OS 120 generates a debug result structure, which is then stored in a memory such as the RAM 102.

[Step S74] The OS 120 analyzes real-time analysis information. For example, based on the debug request structure 70 stored in the common area 40, the OS 120 determines information items to be output. Next, after selecting information items needed to be analyzed in real time from the output target information items, the OS 120 analyzes the selected information items. Note that, among information items set in the debug result structure, ones to be analyzed in real time may be defined in, for example, the first debug function 33.

[Step S75] The OS 120 stores the analysis result of the real-time analysis information in the debug result structure.

[Step S76] The OS 120 determines whether information related to a call to the debug target function 32 matches defined conditions. Note that the OS 120 recognizes the defined conditions based on the debug request structure 70 stored in the common area 40. If the information matches the defined conditions, the OS 120 proceeds to step S77. If not, the OS 120 proceeds to step S80.

[Step S77] The OS 120 analyzes non-real-time analysis information of the output target information items.

[Step S78] The OS 120 stores the analysis result of the non-real-time analysis information in the debug result structure.

[Step S79] The OS 120 hands over the information of the debug result structure to the trace managing unit 130. For example, the OS 120 generates an information linkage structure in which the beginning address of the debug result structure is set, and sets the beginning address of the generated information linkage structure in the common area 40. Then, the trace information outputting unit 136 of the trace managing unit 130 recognizes the beginning address of the information linkage structure with reference to the common area 40, and then recognizes the beginning address of the debug result structure with reference to the information linkage structure. Subsequently, the trace information outputting unit 136 acquires content of the debug result structure.

[Step S80] The OS 120 executes a restore command to restore the content of the registers saved in the RAM 102.

[Step S81] The OS 120 calls the trace target function ‘func_a’.

[Step S82] The OS 120 determines whether to have received a return value from the debug target function 32.

If having received a return value, the OS 120 proceeds to step S83. If not, the OS 120 repeats step S82, waiting for a return value of the debug target function 32.

[Step S83] The OS 120 executes a return instruction to return to the processing of the caller function 31. At this point, the OS 120 uses the return value acquired from the debug target function 32 as a return value to the caller function 31. Subsequently, the OS 120 proceeds to step S71.

In this manner, the debug process accompanied by the trace process using the first method is carried out.

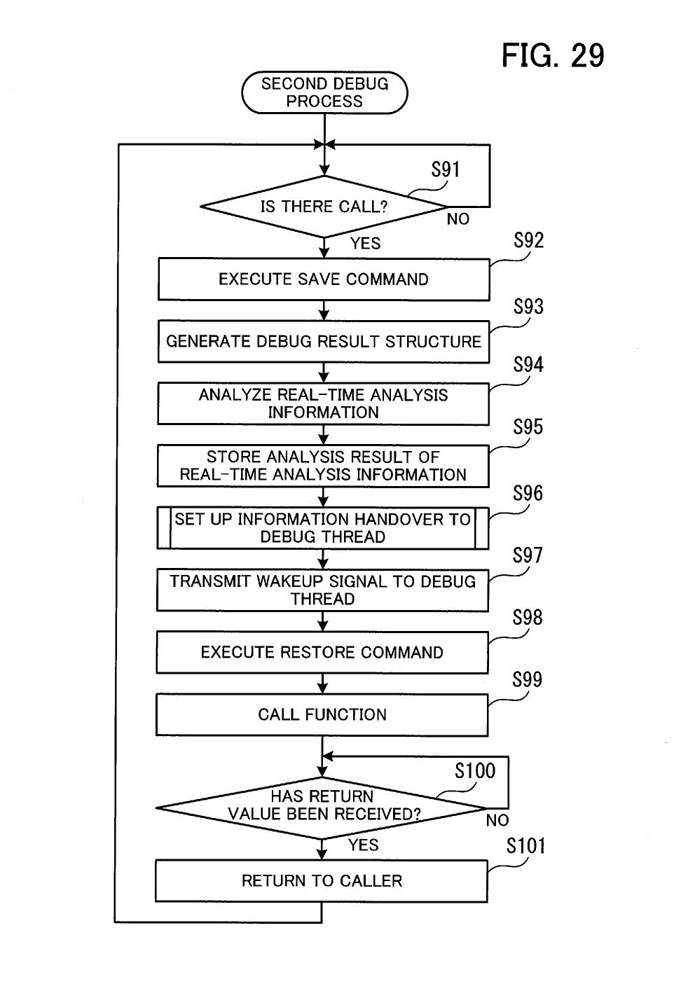

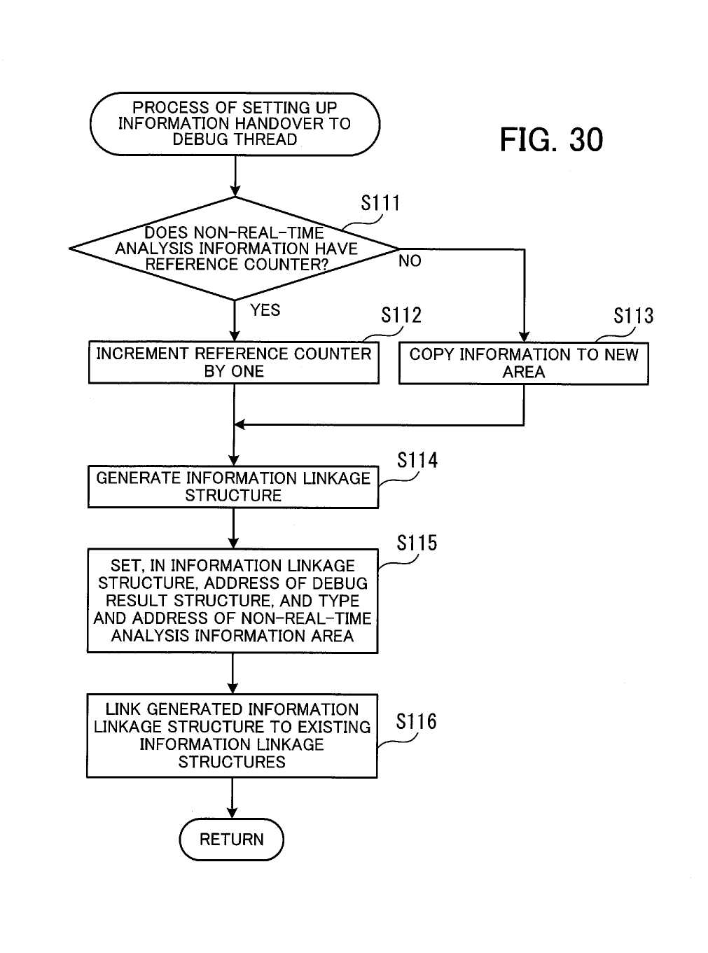

Next described is a second debug process executing the trace process by the second method. FIG. 29 is a flowchart illustrating a procedure example of a second debug process. The process of FIG. 29 is described next according to the step numbers in the flowchart. The process of FIG. 29 is carried out by the computer 100 based on instructions set out in the second debug function 34. Note that processing of steps S91 to S95 and steps S98 to S101 is the same as that of steps S71 to S75 and steps S80 to S83, respectively, in the flowchart of FIG. 28.

[Step S96] The OS 120 carries out a process of setting up information handover to the debug thread 35. This process is described in detail later (see FIG. 30).

[Step S97] The OS 120 transmits a wakeup signal to the debug thread 35. In response to the wakeup signal, the debug thread 35 makes a transition to start-up mode from sleep mode.

FIG. 30 is a flowchart illustrating a procedure example for setting up information handover to a debug thread. The process of FIG. 30 is described next according to the step numbers in the flowchart.

[Step S111] The OS 120 determines whether non-real-time analysis information is stored in an area with a reference counter. In the case where, for example, information in an area identified by an address assigned to a parameter has been designated as an output information target and the information is a message block structure as illustrated in FIG. 6, the non-real-time analysis information is determined to be stored in an area with a reference counter. If the non-real-time analysis information is stored in an area with a reference counter, the OS 120 proceeds to step S112. If not, the OS 120 proceeds to step S113.

[Step S112] The OS 120 increments, by one, the reference counter of the area storing therein the information designated as an output target. Subsequently, the OS 120 proceeds to step S114.

[Step S113] The OS 120 copies information including the non-real-time analysis information designated as an output target to a new memory area in the RAM 102.

[Step S114] The OS 120 generates an information linkage structure.

[Step S115] The OS 120 sets, in the information linkage structure, an address of the debug result structure, a type of the area including the non-real-time analysis information, and a beginning address of the area including the non-real-time analysis information. As for the type of the area including the non-real-time analysis information, ‘1’ is set when the type is a message block structure, and ‘2’ is set when the type is plain data.

[Step S116] The OS 120 links the information linkage structure generated in step S114 to a linkage end of information linkage structures which starts at an address of an information linkage structure stored in the field 41 of the common area 40. For example, the OS 120 sets a beginning address of a memory area of the information linkage structure generated in step S114 in the field for ‘address of next information linkage structure’ of an information linkage structure linked last time. In addition, the OS 120 sets ‘0’ in the field for ‘address of next information linkage structure’ of the information linkage structure generated in step S114.

In the above-described manner, the setup of information handover to the debug thread 35 is completed. The debug thread 35 is woken up in this situation and, then, is able to acquire information of all information linkage structures by sequentially tracing addresses of the information linkage structures with reference to the common area 40. In addition, the debug thread 35 is able to acquire real-time analysis information by referring to the address of the debug result structure provided in each of the information linkage structures. Further, the debug thread 35 is able to recognize information to be analyzed in non-real time by referring to the debug request structure 70 set in the common area 40.

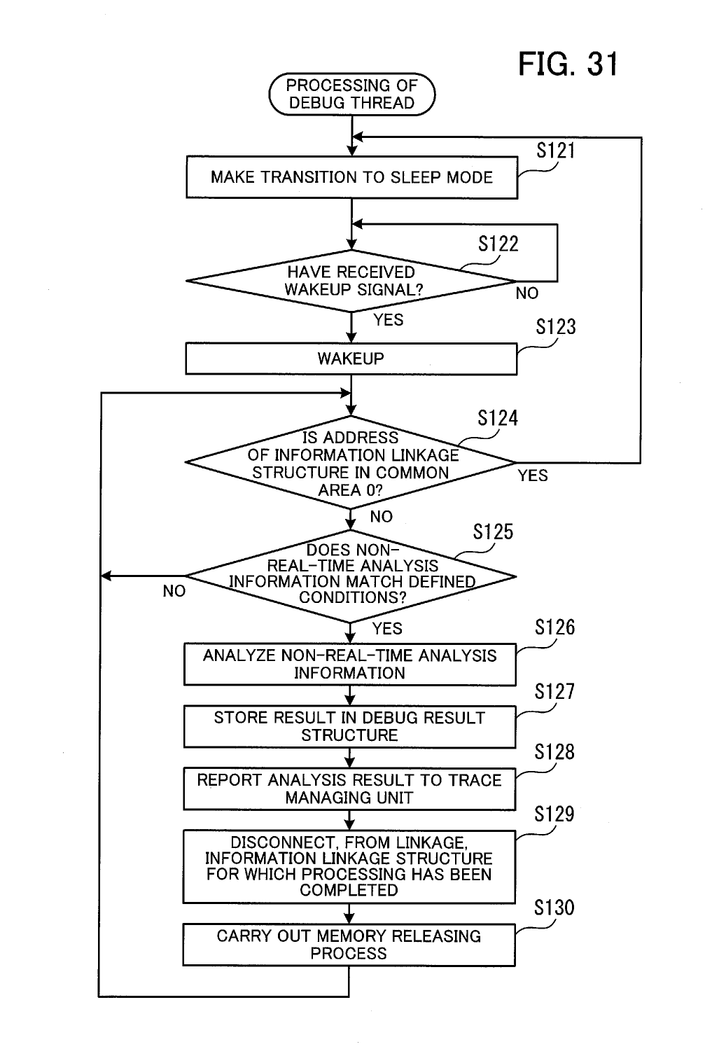

Next described is processing of the debug thread after the information handover. Note that although being one of the functional capabilities of the OS 120, the debug thread 35 is executable in parallel with other processing, such as the processing of the second debug function 34. FIG. 31 illustrates a procedure example of processing of a debug thread. The processing of FIG. 31 is described next according to the step numbers in the flowchart.

[Step S121] The debug thread 35 makes a transition to sleep mode immediately after being generated as well as when ‘0’ is set in the field 41 for ‘address of information linkage structure’ of the common area 40.

[Step S122] The debug thread 35 determines whether a wakeup signal has been input by processing of the second debug function 34. If a wakeup signal has been input, the debug thread 35 proceeds to step S123. If not, the debug thread 35 repeats step S122, waiting for a wakeup signal to be input.

[Step S123] In response to the input of the wakeup signal, the debug thread 35 wakes up (i.e., makes a transition to operating mode).

[Step S124] The debug thread 35 determines whether the ‘address of information linkage structure’ in the field 41 of the common area 40 is ‘0’. If the address is ‘0’, the debug thread 35 determines that there is no information linkage structure to analyze and, then, proceeds to step S121. If the address is other than ‘0’, the debug thread 35 proceeds to step S125.

[Step S125] The debug thread 35 determines that an information linkage structure stored in an area identified by the address set in the field 41 is an analysis target. Next, the debug thread 35 refers to, in the analysis-target information linkage structure, the field for ‘address of non-real-time analysis information area’. Then, the debug thread 35 determines whether non-real-time analysis information stored in an area identified by the referred address matches defined conditions set out in the debug request structure. If the non-real-time analysis information matches the defined conditions, the debug thread 35 proceeds to step S126. If not, the debug thread 35 proceeds to step S124.

[Step S126] The debug thread 35 analyzes the non-real-time analysis information. For example, the debug thread 35 refers to, in the analysis-target information linkage structure, the field for ‘address of non-real-time analysis information area’. Subsequently, from the non-real-time analysis information stored in an area identified by the referred address, the debug thread 35 extracts an extraction part designated in the debug request structure, and then uses the extraction part as an analysis result.

[Step S127] The debug thread 35 stores the analysis result in a debug result structure in an area identified by the ‘address of debug result structure’ set in the analysis-target information linkage structure.

[Step S128] The debug thread 35 reports the analysis result to the trace managing unit 130. For example, the debug thread 35 hands over a copy of the debug result structure having the analysis result therein to the trace managing unit 130.

[Step S129] The debug thread 35 disconnects, from the linkage, the information linkage structure for which the analysis process has been completed. For example, the debug thread 35 sets, in the field 41 for ‘address of information linkage structure’ of the common area 40, an address in the field for ‘address of next information linkage structure’ of the analysis-target information linkage structure.

[Step S130] The debug thread 35 carries out a memory releasing process. For example, the debug thread 35 releases memory areas for the information linkage structure, the debug result structure, and the non-real-time analysis information. Note that in the case where a release-target area has a reference counter, the debug thread 35 decrements the reference counter by one, and then carries out the memory releasing process only if the reference counter reaches 0. Subsequently, the debug thread 35 proceeds to step S124.

In the above-described manner, processing of the caller is not delayed even when extensive analysis or a large amount of copying takes place. That is, it is believed that extensive analysis takes place when non-real-time analysis information is analyzed. In addition, it is believed that a large amount of copy processing takes place at the time of reporting analysis results to the trace managing unit 130. In view of this, when extensive analysis or a large amount of copying takes place, it is possible to reduce delay in response to the caller by analyzing non-real-time analysis information in a different thread. This in turn reduces delay in processing of the caller due to the execution of the trace process.

Note that the number of caller functions is not limited to one and may be more. For example, all programs individually including a call instruction to the debug target function 32 subject to the trace process may be caller functions.

According to the second embodiment, the implementation of the trace process at the time of calling the debug target function 32 is enabled by rewriting a call instruction to the debug target function 32 in the caller function 31 with a call instruction to a debug function. With this, the trace process is implemented without a save command in the debug target function 32. That is, if a save command is located at the top of the debug target function 32, the trace process may be implemented by rewriting the save command with a call instruction to the debug function. However, in this case, the trace process cannot be implemented for the debug target function 32 not having a save command. Changing a function call instruction with a call instruction to a debug function, as in the case of the second embodiment, enables the trace process to be implemented for a call to the debug target function 32 not having a save command, thus expanding the versatility of the trace process.

In addition, according to the second embodiment, it is possible to limit trace information reported from the kernel space to the user space by defined conditions and output information, thus promoting the process efficiency. A part of the trace information may be output to a user using an application program in the user space. However, in this case, the entire trace information is transferred from a functional capability operating in the kernel space to a functional capability operating in the user space, and then the user application determines the need of each information item and discard needless information items. That is, the process efficiency is undermined by needless information analysis and result transfer. According to the second embodiment, on the other hand, as for information not matching the defined conditions, no analysis result is transferred to the trace managing unit 130. This promotes the efficiency of the debug process, and also reduces the amount of data transferred from the kernel space to the user space.

In addition, according to the second embodiment, only designated output information items are extracted by a debug process program or a debug thread operating in the kernel space and, then, reported to the trace managing unit 130. This reduces the amount of information to be analyzed, thus promoting the efficiency of the debug process and also reducing the amount of data transferred from the kernel space to the user space.

Further, according to the second embodiment, the defined conditions are designated independently of data representation in the kernel space. That is, according to the second embodiment, the debug request structure 70 is specified as an interface (data configuration) for data handover between the trace managing unit 130 and a functional capability in the kernel space. The trace managing unit 130 converts designated information items into a form according to the specified interface (data configuration), then acquires the common area 40 in the kernel space, and copies the debug request structure 70 to the common area 40. This allows data representation in the kernel space to be determined in the kernel space, which in turn allows the trace managing unit 130 to readily designate output information items and defined conditions.

### (c) Other Embodiments

Note that the processing features described in each of the embodiments above may be achieved by a computer. In this case, a program is provided which describes processing contents of the functional capabilities to be held by the computer. By executing the program on the computer, the above-described processing features are achieved on the computer. The program in which the processing contents are described may be recorded on computer-readable recording media. Such computer-readable recording media include a magnetic storage device, an optical disk, a magneto-optical recording medium, and a semiconductor memory. Examples of the magnetic storage device are a HDD, a flexible disk (FD), and a magnetic tape. Examples of the optical disk are a DVD, a DVD-RAM, a CD-ROM, and a CD-RW. An example of the magneto-optical recording medium is a magneto-optical disk (MO).

To distribute the program, for example, portable recording media, such as DVDs and CD-ROMs, on which the program is recorded are sold. In addition, the program may be stored in a memory device of a server computer and then transferred from the server computer to another computer via a network.

A computer for executing a program stores, for example, in its own memory device, the program which is originally recorded on a portable recording medium or transferred from the server computer. Subsequently, the computer reads the program from its own memory device and performs processing according to the program. Note that the computer is able to read the program directly from the portable recording medium and perform processing according to the program. In addition, the computer is able to sequentially perform processing according to a received program each time such a program is transferred from the server computer.

In addition, at least part of the above-described processing features may be achieved by an electronic circuit, such as a digital signal processor (DSP), an application specific integrated circuit (ASIC), and a programmable logic device (PLD).

According to one aspect, it is possible to reduce delay in processing of a caller of a program due to execution of a trace process at the time of calling the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the designation relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a processor configured to perform a procedure including:
determining, based on an analysis request to analyze information related to a call to a first program, which one of a first and a second method has shorter time to respond to a caller when the call to the first program is made, the first method being to analyze, in real time, all of information items designated as analysis targets in the analysis request, and the second method being to analyze, in non-real time, some of the information items designated in the analysis request and analyze, in real time, information items other than the information items to be analyzed in non-real time; and
carrying out, when the first method has shorter response time, a first task in real time at a time of execution of a call instruction to the first program during a course of execution of a second program including therein the call instruction to the first program, the first task including analysis of all of the information items designated in the analysis request, execution of processing of the first program, and a response to the call to the first program, and carrying out, when the second method has shorter response time, a second task in real time at the time of execution of the call instruction to the first program during the course of execution of the second program and a third task in non-real time, the second task including analysis of the information items other than the information items to be analyzed in non-real time, a request for analysis of the information items to be analyzed in non-real time, execution of processing of the first program, and a response to the call to the first program, and the third task including the analysis of the information items to be analyzed in non-real time.

2. The information processing apparatus according to claim 1, wherein the determining includes comparing a first and a second processing time, and determining that the first method has shorter response time when the second processing time is longer and determining that the second method has shorter response time when the first processing time is longer, the first processing time being a time for processing not needing to be carried out in real time due to the some of the information items designated in the analysis request being analyzed in non-real time, and the second processing time being a time for newly emerging processing needing to be carried out in real time due to the some of the information items designated in the analysis request being analyzed in non-real time.

3. The information processing apparatus according to claim 2, wherein the first processing time is an addition of a time for the analysis of the information items to be analyzed in non-real time to a time to output an analysis result.

4. The information processing apparatus according to claim 2, wherein the second processing time is a time for a real-time process to request the analysis of the information items to be analyzed in non-real time.

5. The information processing apparatus according to claim 1, wherein the processor writes, by a process in a user space, content of the designation of the analysis targets in the analysis request into a common area reserved in a kernel space, and carries out the real-time analysis in the kernel space according to the content of the designation written in the common area.

6. The information processing apparatus according to claim 1, wherein
a condition for analyzing the information related to the call to the first program at the time of execution of the call instruction to the first program during the course of execution of the second program is set out in content of the designation of the analysis targets in the analysis request, and
the processor carries out the analysis of the information related to the call to the first program when the condition set out in the analysis request is satisfied.

7. The information processing apparatus according to claim 1, wherein
in the analysis request, at least part of the information related to the call to the first program is designated as an output target, and
the processor acquires information designated as the output target in the analysis request from the information related to the call to the first program and outputs the acquired information.

8. The information processing apparatus according to claim 1, wherein
the information items to be analyzed in non-real time have, because of a data configuration thereof, a setting feature to prevent a memory area storing therein the information items to be analyzed in non-real time from being released, and
the processor prevents, by a real-time process, the memory area from being released and subsequently analyzes the information items to be analyzed in non-real time.

9. The information processing apparatus according to claim 1, wherein the processor generates a third program including therein processing of one of the first and the second method having shorter response time, and replaces the call instruction to the first program in the second program with a call instruction to the third program.

10. A computer-readable storage medium storing a computer program, the computer program causing a computer to perform a procedure comprising:
determining, based on an analysis request to analyze information related to a call to a first program, which one of a first and a second method has shorter time to respond to a caller when the call to the first program is made, the first method being to analyze, in real time, all of information items designated as analysis targets in the analysis request, and the second method being to analyze, in non-real time, some of the information items designated in the analysis request and analyze, in real time, information items other than the information items to be analyzed in non-real time; and
carrying out, when the first method has shorter response time, a first task in real time at a time of execution of a call instruction to the first program during a course of execution of a second program including therein the call instruction to the first program, the first task including analysis of all of the information items designated in the analysis request, execution of processing of the first program, and a response to the call to the first program, and carrying out, when the second method has shorter response time, a second task in real time at the time of execution of the call instruction to the first program during the course of execution of the second program and a third task in non-real time, the second task including analysis of the information items other than the information items to be analyzed in non-real time, a request for analyzing the information items to be analyzed in non-real time, execution of processing of the first program, and a response to the call to the first program, and the third task including the analysis of the information items to be analyzed in non-real time.

11. An analysis method comprising:
determining, by a processor, based on an analysis request to analyze information related to a call to a first program, which one of a first and a second method has shorter time to respond to a caller when the call to the first program is made, the first method being to analyze, in real time, all of information items designated as analysis targets in the analysis request, and the second method being to analyze, in non-real time, some of the information items designated in the analysis request and analyze, in real time, information items other than the information items to be analyzed in non-real time; and
carrying out, by the processor, when the first method has shorter response time, a first task in real time at a time of execution of a call instruction to the first program during a course of execution of a second program including therein the call instruction to the first program, the first task including analysis of all of the information items designated in the analysis request, execution of processing of the first program, and a response to the call to the first program, and carrying out, when the second method has shorter response time, a second task in real time at the time of execution of the call instruction to the first program during the course of execution of the second program and a third task in non-real time, the second task including analysis of the information items other than the information items to be analyzed in non-real time, a request for analyzing the information items to be analyzed in non-real time, execution of processing of the first program, and a response to the call to the first program, and the third task including the analysis of the information items to be analyzed in non-real time.
